(19) United States
(12) Patent Application Publication
(10) Pub. No.: US 2026/0319346 A1
(43) Pub. Date: Oct. 15, 2026

(54) ACCESSORY MOUNT, ACCESSORY, CAMERA MOUNT, AND IMAGE PICKUP APPARATUS

(71) Applicant: CANON KABUSHIKI KAISHA, Tokyo (JP)

(72) Inventor: HONAMI WATANABE, Tochigi (JP)

(21) Appl. No.: 19/576,571

(22) Filed: Mar. 24, 2026

(30) Foreign Application Priority Data
Apr. 14, 2025 (JP) 2025-066036

(51) Int. Cl. G03B 17/56; G03B 17/14; H01R 13/652; H01R 13/73

(52) U.S. Cl. CPC G03B 17/565; G03B 17/14; H01R 13/652; H01R 13/73

(57) ABSTRACT

An accessory mount may be attachable to and detachable from a camera mount that includes a first terminal portion. The accessory mount may include a second terminal portion configured to contact the first terminal portion while the accessory mount is attached to the camera mount. The second terminal portion may include a plurality of terminals configured to contact a plurality of terminals of the first terminal portion, and at least one terminal configured not to contact any of the plurality of terminals of the first terminal portion while the accessory mount is attached to the camera mount.

### BACKGROUND

### Field of the Technology

The present disclosure relates to an accessory mount, an accessory, a camera mount, and an image pickup apparatus.

### Description of the Related Art

Japanese Patent Application Laid-Open No. 2018-205733 discloses an accessory apparatus that is attachable to and detachable from an image pickup apparatus.

### SUMMARY

An accessory mount according to one aspect of the present disclosure may be attachable to and detachable from a camera mount that includes a first terminal portion. The accessory mount may include a second terminal portion configured to contact the first terminal portion while the accessory mount is attached to the camera mount. The second terminal portion may include a plurality of terminals configured to contact a plurality of terminals of the first terminal portion, and at least one terminal configured not to contact any of the plurality of terminals of the first terminal portion while the accessory mount is attached to the camera mount. An accessory having the above accessory mount also constitutes another aspect of the present disclosure. A camera mount having the above first terminal portion also constitutes another aspect of the present disclosure. An image pickup apparatus having the above camera mount also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIGS. 1A and 1B are diagrams illustrating a relationship among an image pickup apparatus, a lens apparatus, and an intermediate accessory apparatus in the present embodiment.

FIGS. 2A, 2B, 2C, and 2D are schematic diagrams of a mount portion according to a comparative example.

FIG. 3 is a block diagram of the image pickup apparatus and the lens apparatus in the present embodiment.

FIG. 4 is a block diagram of the image pickup apparatus, the lens apparatus, and the intermediate accessory apparatus in the present embodiment.

FIG. 5 is a block diagram of the image pickup apparatus and the intermediate accessory apparatus in the present embodiment, and a lens apparatus according to a conventional example.

FIGS. 6A, 6B, 6C, 6D, and 6E are schematic diagrams of peripheral circuits of TYPE terminals in the present embodiment.

FIG. 7 is a flowchart illustrating an operation of the image pickup apparatus when the lens apparatus is attached in the present embodiment.

FIG. 8 is a flowchart illustrating second communication in the present embodiment.

FIG. 9 is a diagram illustrating a broadcast communication mode of third communication in the present embodiment.

FIG. 10 is a diagram illustrating a P2P communication mode of third communication in the present embodiment.

FIGS. 11A, 11B, 11C, and 11D are schematic diagrams of a camera-side contact holder and an accessory-side contact holder according to a comparative example and the present embodiment.

FIGS. 12A and 12B are diagrams illustrating a case where a DGND terminal and a terminal adjacent to the DGND terminal are short-circuited in a comparative example and the present embodiment.

FIGS. 13A, 13B, and 13C are diagrams illustrating a case where an LCLK terminal and a terminal adjacent to the LCLK terminal are short-circuited in a comparative example and the present embodiment.

FIG. 14 is an exploded perspective view illustrating an example of a mount portion in the present embodiment.

### DESCRIPTION OF THE EMBODIMENTS

Referring now to the accompanying drawings, a detailed description will be given of embodiments according to the present disclosure.

First, prior to a description of the present embodiment, a variety of terms used in the present specification will be discussed. An accessory (accessory apparatus) refers to an apparatus that can be attached to and detached from an image pickup apparatus (camera body). The image pickup apparatus and the accessory apparatus are attached by coupling a camera mount provided on the image pickup apparatus with an accessory mount (mount apparatus) provided on the accessory apparatus. The accessory includes a lens apparatus having an imaging optical system. The accessory further includes an intermediate accessory apparatus that is attachable between the lens apparatus and the image pickup apparatus. The camera mount and the accessory mount are coupling portions provided on the image pickup apparatus and the accessory apparatus, respectively. Electrical contacts are provided on each of the camera mount and the accessory mount, and when the accessory apparatus is attached to the image pickup apparatus, the electrical contacts provided on the camera mount and the accessory mount come into contact with each other.

That is, the camera mount and the accessory mount have not only a function of mechanically coupling the image pickup apparatus and the accessory apparatus but also a function of electrically connecting the image pickup apparatus and the accessory apparatus.

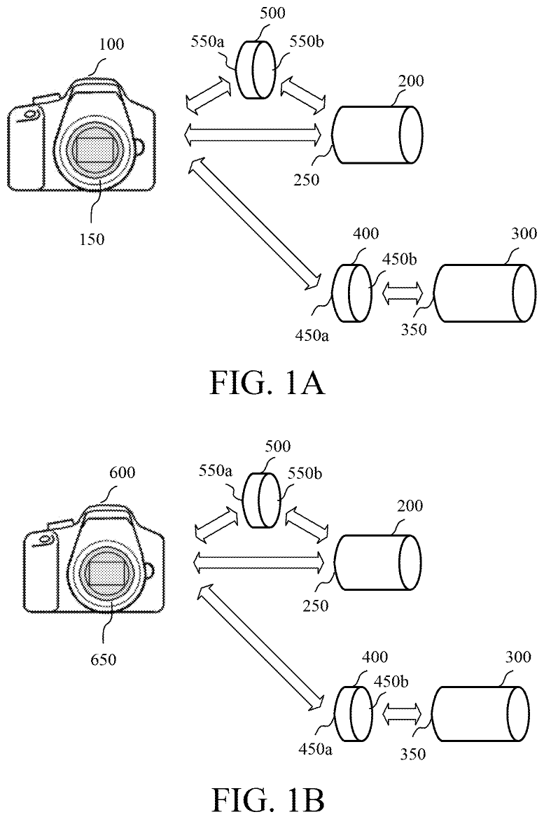

Next, with reference to FIGS. 1A and 1B, a relationship among an image pickup apparatus, a lens apparatus, and an intermediate accessory apparatus that constitute an imaging system according to the present embodiment will be described. FIG. 1A illustrates the relationship among a camera body (image pickup apparatus) 100, a lens apparatus (interchangeable lens) 200, intermediate accessory apparatuses 400 and 500, and a lens apparatus 300 having a configuration different from that of the lens apparatus 200. Apparatuses indicated by arrows in FIG. 1A can be attached to each other by coupling their mount portions. The camera body 100 includes an image sensor such as a CMOS sensor or a CCD sensor. By attaching the lens apparatus 200 or the lens apparatus 300 to the camera body 100, an object can be imaged.

FIG. 1B illustrates a relationship among an inspection apparatus (inspection image pickup apparatus) 600 according to the present embodiment, the lens apparatus 200 according to the present embodiment, the intermediate accessory apparatuses 400 and 500 according to the present embodiment, and a lens apparatus 300 according to prior art having a configuration different from that of the lens apparatus according to the present embodiment. By attaching the lens apparatus 200 or the lens apparatus 300 to the inspection apparatus 600, each lens apparatus can be inspected.

The lens apparatus 200, the intermediate accessory apparatus 500, and the intermediate accessory apparatus 400 can be directly attached to the camera body 100 and the inspection apparatus 600. That is, a mount portion 250 of the lens apparatus 200, a mount portion 550a of the intermediate accessory apparatus 500, and a mount portion 450a of the intermediate accessory apparatus 400 have shapes capable of being coupled to a mount portion 150 of the camera body 100 and a mount portion 650 of the inspection apparatus 600.

The intermediate accessory apparatus 500 includes the mount portion 550a attachable to the camera body 100 and the inspection apparatus 600. The intermediate accessory apparatus 500 further includes a mount portion 550b having the same shape as the mount portion 150 of the camera body 100. Thus, the lens apparatus 200 can also be attached to the intermediate accessory apparatus 500. In other words, the lens apparatus 200 can be attached to the camera body 100 and the inspection apparatus 600 via the intermediate accessory apparatus 500. Another intermediate accessory apparatus (not illustrated) may be attached between the lens apparatus 200 and the intermediate accessory apparatus 500. In this case, two intermediate accessory apparatuses are attached between the lens apparatus 200 and the camera body 100 or the inspection apparatus 600.

On the other hand, the shape of the mount portion 150 is such that the mount portion 350 of the lens apparatus 300 cannot be coupled thereto. Therefore, the lens apparatus 300 cannot be directly attached to the camera body 100 and the inspection apparatus 600. However, the lens apparatus 300 can be attached to the camera body 100 and the inspection apparatus 600 via the intermediate accessory apparatus 400 that includes the mount portion 450a and a mount portion 450b to which the lens apparatus 300 can be attached. Thus, one of a plurality of lens apparatuses including the lens apparatus 200 and the lens apparatus 300 is selectively attached to the camera body 100 and the inspection apparatus 600.

The mount portion 150 of the camera body 100 and the mount portion 650 of the inspection apparatus 600 each correspond to a first mount portion. The mount portion 250 of the lens apparatus 200, the mount portion 550a of the intermediate accessory apparatus 500, and the mount portion 450a of the intermediate accessory apparatus 400 each correspond to a second mount portion.

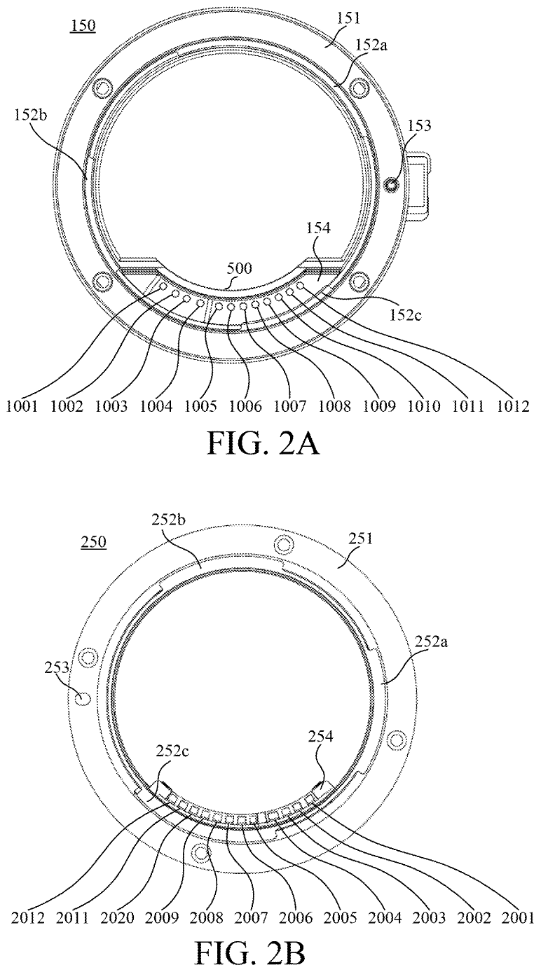

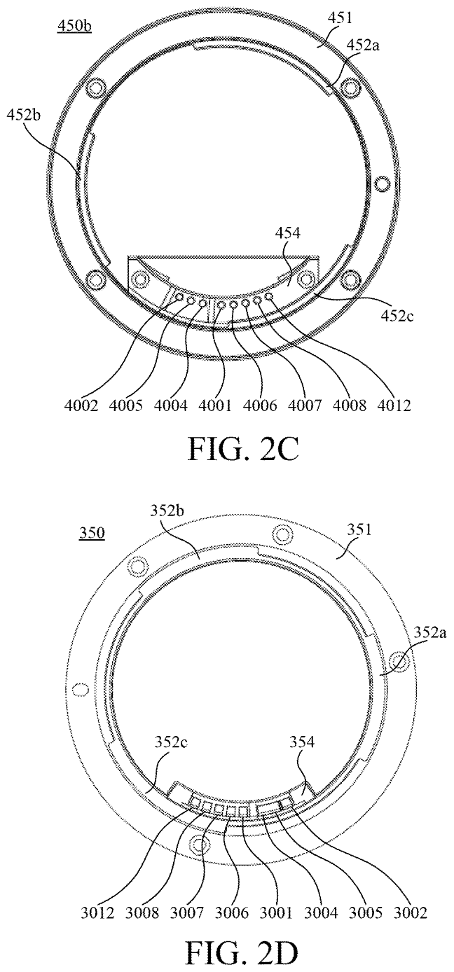

Next, with reference to FIGS. 2A, 2B, 2C, and 2D, mount portions of the camera body 100, the lens apparatus 200, the lens apparatus 300, the intermediate accessory apparatus 500, and the intermediate accessory apparatus 400 according to a comparative example will be described. FIG. 2A is a schematic diagram of the mount portion 150 of the camera body 100 when viewed from an object side. FIG. 2B is a schematic diagram of the mount portion 250 of the lens apparatus 200 when viewed from an image-plane side. FIG. 2B corresponds to a comparative example compared with the present embodiment, and as described later, does not illustrate at least one terminal (2013 to 2016) that does not contact any of a plurality of terminals in a first terminal portion. FIG. 2C is a schematic diagram of a mount portion 450b of the intermediate accessory apparatus 400 when viewed from the object side. FIG. 2D is a schematic diagram of the mount portion 350 of the lens apparatus 300 when viewed from the image-plane side.

The mount portion 150 is provided on a front side (object side) of the camera body 100. The mount portion 150 includes an annular (ring-shaped) mount reference surface 151 for securing a predetermined flange back. On an inner side of the mount reference surface 151, bayonet claws 152a to 152c are provided at three positions in a circumferential direction. In the mount portion 150, a lock pin 153 for positioning when bayonet-coupling a mount portion of the accessory apparatus to the mount portion 150 is provided so that it can protrude and retract relative to the mount reference surface 151. When the mount portion 150 and the mount portion of the accessory apparatus are rotated relative to each other to a position at which the attachment is completed, a fitting hole (engagement hole) provided in the mount portion of the accessory apparatus is engaged with the lock pin 153.

In a region on an inner side of the bayonet claws 152a to 152c, a camera-side contact holder 154 is provided. The camera-side contact holder 154 holds electrical contacts (camera-side electrical contacts, first terminal portion) 1001 to 1012.

The mount portion 550b of the intermediate accessory apparatus 500 and the mount portion 650 of the inspection apparatus 600 have a configuration similarly to the mount portion 150 illustrated in FIG. 2A.

The mount portion 250 is fixed to a rear end portion (image-plane side) of the lens apparatus 200. The mount portion 250 includes a ring-shaped mount reference surface 251 serving as a reference surface of the flange back. On an inner side of the mount reference surface 251, bayonet claws 252a to 252c are provided at three positions in a circumferential direction. The mount portion 250 is provided with a fitting hole 253. The fitting hole 253 is engaged with the lock pin 153 when the attachment of the lens apparatus 200 to the camera body 100 is completed.

In a region on an inner side of the bayonet claws 252a to 252c, an accessory-side contact holder (terminal holder) 254 is provided. The accessory-side contact holder 254 holds electrical contacts (lens-side electrical contacts, second terminal portion) 2001 to 2012 arranged along the circumferential direction about an optical axis.

The mount portion 550a of the intermediate accessory apparatus 500 and the mount portion 450a of the intermediate accessory apparatus 400 have configurations similar to the configuration of the mount portion 250 illustrated in FIG. 2B. That is, each of the mount portions 550a and 450a includes an accessory-side contact holder that holds electrical contacts (accessory-side electrical contacts) 2001 to 2012.

The mount portion 450b includes, similarly to the mount portion 150, a mount reference surface 451, bayonet claws 452a to 452c, and a contact holder 454 in which electrical contacts 4001, 4002, 4004 to 4008, and 4012 are arranged. However, a length of the bayonet claws 452a to 452c and a distance between the bayonet claws differ from those of the bayonet claws 152a to 152c of the mount portion 150.

The mount portion 350 includes, similarly to the mount portion 250, a mount reference surface 351, bayonet claws 352a to 352c, and a contact holder 354 in which electrical contacts 3001, 3002, 3004 to 3008, and 3012 are arranged. However, a length of the bayonet claws 352a to 352c and a distance between adjacent bayonet claws differ from those of the bayonet claws 252a to 252c of the mount portion 250.

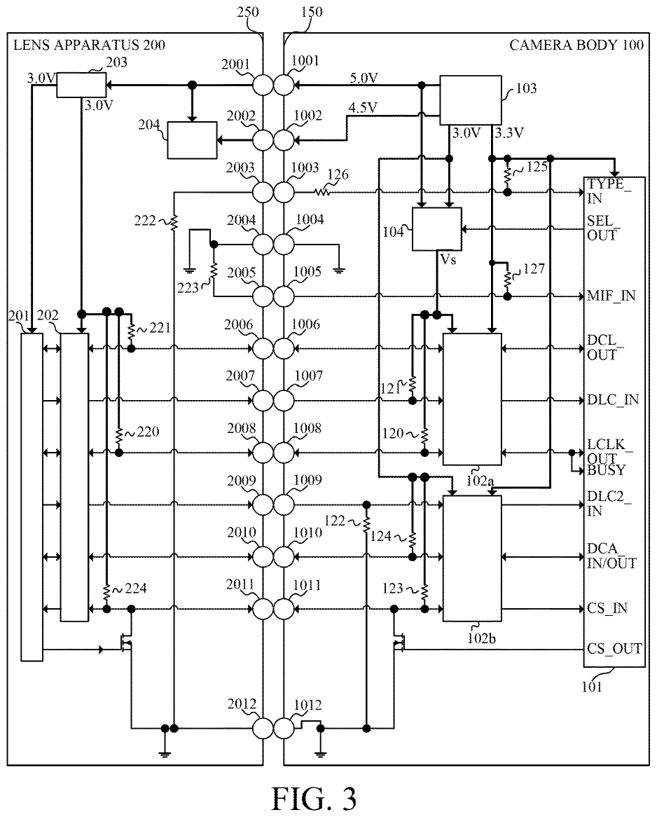

Next, with reference to FIG. 3, a case where the lens apparatus 200 is attached to the camera body 100 will be described. FIG. 3 is a block diagram illustrating a circuit configuration in a state where the lens apparatus 200 is connected to the camera body 100. The lens apparatus 200 and the camera body 100 are configured to be communicable with each other via a communication path formed by some of a plurality of electrical contacts provided in the mount portions 150 and 250. The lens apparatus 200 and the camera body 100 can perform first communication, second communication, and third communication described later.

A camera control unit 101 controls output of the electrical contacts provided in the mount portion 150 and processes signals input to the electrical contacts, thereby controlling communication performed with the accessory apparatus attached to the camera body 100.

A camera power supply unit 103 is a power supply used for operations of each component of the camera body 100 and the accessory apparatus attached to the camera body 100. The camera power supply unit 103 generates a plurality of different voltages and supplies power of each voltage to each component of the camera body 100 or the accessory apparatus attached to the camera body 100.

A power switching unit 104 supplies power to a first communication I/F (interface) unit (I/F unit for the first communication) 102a. Two power supplies having different voltage values are supplied from the camera power supply unit 103 to the power switching unit 104, and under control of the camera control unit 101, the power switching unit 104 is capable of switching the power to be supplied to the first communication I/F unit 102a.

A lens control unit 201 controls output of the electrical contacts provided in the mount portion 250 and processes signals input to the electrical contacts, thereby controlling communication performed between the camera body 100 and the lens apparatus 200.

A lens power supply unit 203 generates a power supply of a predetermined voltage from the power supplied from the camera body 100 and supplies the generated power to the lens control unit 201 and a lens-side communication I/F unit 202.

The electrical contact 1001 and electrical contact (third terminal) 2001 are terminals used to supply, from the camera power supply unit 103 of the camera body 100 to the lens apparatus 200, power (communication power) mainly used for controlling communication between the camera body 100 and the lens apparatus 200. That is, the electrical contacts 1001 and 2001 are power supply terminals used for receiving power from the camera mount. Hereinafter, the electrical contacts 1001 and 2001 are also referred to as a VDD terminal 1001 and a VDD terminal 2001. In the present embodiment, the voltage of power supplied to the lens apparatus 200 by the VDD terminal 1001 (hereinafter referred to as a VDD voltage) is 5.0 V.

The electrical contacts 1002 and 2002 are terminals used to supply, from the camera body 100 to the lens apparatus 200, power (drive power) mainly used for operation of a drive system such as motors. Hereinafter, the electrical contacts 1002 and 2002 are also referred to as a VBAT terminal 1002 and a VBAT terminal 2002. In the present embodiment, the voltage of power supplied to the lens apparatus 200 by the VBAT terminal 1002 (hereinafter referred to as a VBAT voltage) is 4.5 V. The VDD terminal and the VBAT terminal are also collectively referred to as power-system terminals.

The electrical contacts 1012 and 2012 are terminals that connect a communication control circuit of the camera body 100 and the lens apparatus 200 to ground (ground level), i.e., grounding terminals corresponding to the VDD terminals. Hereinafter, the electrical contacts 1012 and 2012 are also referred to as a DGND terminal 1012 and a DGND terminal 2012.

The electrical contacts 1004 and 2004 are terminals for connecting, to ground (ground level), drive-system circuits including motors and the like provided in the camera body 100 and the lens apparatus 200, i.e., grounding terminals corresponding to the VBAT terminals. Hereinafter, the electrical contacts 1004 and 2004 are also referred to as a PGND terminal 1004 and a PGND terminal 2004. The DGND terminals and the PGND terminals are also collectively referred to as ground terminals.

The electrical contact 1005 and electrical contact (fourth terminal) 2005 are terminals for detecting that the lens apparatus has been attached to the camera body 100 (detection terminals used to detect that the accessory mount has been attached to the camera mount). The camera control unit 101 detects the attachment or detachment of the lens apparatus to/from the camera body 100 in accordance with the voltage level of the electrical contact 1005. When the camera control unit 101 detects the attachment of the lens apparatus, the camera control unit 101 starts supplying power to the lens apparatus via the VDD terminal 1001 and the VBAT terminal 1002. Hereinafter, the electrical contacts 1005 and 2005 are also referred to as an MIF terminal 1005 and an MIF terminal 2005.

The electrical contacts 1003 and 2003 are terminals for identifying a type of the accessory apparatus attached to the camera body 100. The electrical contact 1003 is pulled up, in the camera body 100, to the same voltage as the power supplied to the camera control unit 101 via a resistor 125. The electrical contact 2003 is pulled down, in the lens apparatus 200, to ground (DGND) via a resistor 222. The camera control unit 101 detects the voltage value of the electrical contact 1003 and identifies the type of the accessory apparatus attached to the camera body 100 based on the detected voltage value. That is, the camera control unit 101 also functions as an identifying unit for identifying the type of the attached accessory apparatus. The camera control unit 101 also controls the power switching unit 104 to switch, by the power switching unit 104, the power supplied to the first communication I/F unit 102a in accordance with the type of the accessory apparatus attached to the camera body 100. Thereby, the camera body 100 and the accessory apparatus attached to the camera body 100 can communicate at a proper communication voltage. Hereinafter, the electrical contacts 1003 and 2003 are also referred to as a TYPE terminal 1003 and a TYPE terminal 2003.

The electrical contacts 1006 to 1008 and 2006 to 2008 are terminals used for the first communication described later. Input/output of the electrical contacts 1006 to 1008 is controlled by the camera control unit 101 via the first communication I/F unit 102a. Input/output of the electrical contacts 2006 to 2008 is controlled by the lens control unit 201 via the lens-side communication I/F unit 202.

The electrical contacts 1008 and 2008 are terminals capable of outputting, from the camera body 100 to the lens apparatus 200, a clock signal used for first communication. The electrical contacts 1008 and 2008 are also used for the lens apparatus 200 to notify the camera body 100 of a communication standby request. Hereinafter, the electrical contacts 1008 and 2008 are also referred to as an LCLK terminal 1008 and an LCLK terminal 2008. The LCLK terminal 1008 is pulled up, in the camera body 100, to the same potential as an interface voltage of the first communication I/F unit 102a via a resistor 120. The LCLK terminal 2008 is pulled up, in the lens apparatus 200, to the same potential as an interface voltage of the lens-side communication I/F unit 202 via a resistor 220.

The electrical contacts 1006 and 2006 are terminals capable of transmitting data from the camera body 100 to the lens apparatus 200 by the first communication. Hereinafter, the electrical contacts 1006 and 2006 are also referred to as DCL terminals 1006 and 2006. The DCL terminal 2006 is pulled up, in the lens apparatus 200, to the same potential as the interface voltage of the lens-side communication I/F unit 202 via a resistor 221.

The electrical contacts 1007 and 2007 are terminals capable of transmitting data from the lens apparatus 200 to the camera body 100 by the first communication. Hereinafter, the electrical contacts 1007 and 2007 are also referred to as DLC terminals 1007 and 2007. The DLC terminal 1007 is pulled up, in the camera body 100, to the same potential as the interface voltage of the first communication I/F unit 102a via a resistor 121.

Hereinafter, the LCLK terminal 1008, the DCL terminal 1006, and the DLC terminal 1007 used for the first communication are also referred to as a first camera-side electrical contact group. The LCLK terminal 2008, the DCL terminal 2006, and the DLC terminal 2007 are also referred to as a first lens-side electrical contact group.

The electrical contacts 1009 and 2009 are used for second communication described later. The electrical contacts 1009 and 2009 are terminals capable of transmitting data from the lens apparatus 200 to the camera body 100 by second communication. Hereinafter, the electrical contacts 1009 and 2009 are also referred to as a DLC2 terminal 1009 and a DLC2 terminal 2009. The DLC2 terminal 1009 is pulled down, in the camera body 100, to the same potential as the DGND terminal via a resistor 122.

The electrical contacts 1010, 1011, 2010, and 2011 are terminals used for the third communication described later.

The electrical contacts 1010 and 2010 are terminals capable of bidirectionally transmitting and receiving data between the camera body 100 and the lens apparatus 200 by the third communication. Hereinafter, the electrical contacts 1010 and 2010 are also referred to as a DCA terminal 1010 and a DCA terminal 2010. The DCA terminal 1010 is pulled up, in the camera body 100, to the same potential as an interface voltage of a second/third-communication I/F unit (I/F unit for the second and third communications) 102b via a resistor 124. The DCA terminal 1010 is also connected to the camera control unit 101 via a CMOS-type input/output interface. Similarly, the DCA terminal 2010 is connected to the lens control unit 201 via a CMOS-type input/output interface. Thus, the camera control unit 101 and the lens control unit 201 can transmit and receive high-speed data using the DCA terminals 1010 and 2010.

The electrical contacts 1011 and 2011 are terminals capable of notifying a predetermined timing (described later) related to the third communication between the camera body 100 and the lens apparatus 200. Hereinafter, the electrical contacts 1011 and 2011 are also referred to as a CS terminal 1011 and a CS terminal 2011. The CS terminal 1011 is pulled up, in the camera body 100, to the same potential as the interface voltage of the second/third-communication I/F unit 102b via a resistor 123. The CS terminal 2011 is pulled up, in the lens apparatus 200, to the same potential as the interface voltage of the lens-side communication I/F unit 202 via a resistor 224. The CS terminal 1011 is connected to the camera control unit 101 via an open-type output interface. Similarly, the CS terminal 2011 is connected to the lens control unit 201 via an open-type output interface. Here, the open-type output interface refers to an output interface that is an open drain or an open collector.

In the present embodiment, in a case where the lens apparatus 200 is attached to the camera body 100, the interface voltages of the first communication I/F unit 102a and the second/third-communication I/F unit 102b are set to 3.0 V (a first voltage). The interface voltage of the lens-side communication I/F unit 202 is also set to 3.0 V (the first voltage). Hereinafter, the electrical contacts 1006 to 1011 used for performing communication with the attached accessory apparatus are also referred to as camera-side communication contacts. The electrical contacts 2006 to 2011, which are electrical contacts that contact the camera-side communication contacts when the lens apparatus 200 is attached to the camera body 100, are also referred to as accessory-side communication contacts.

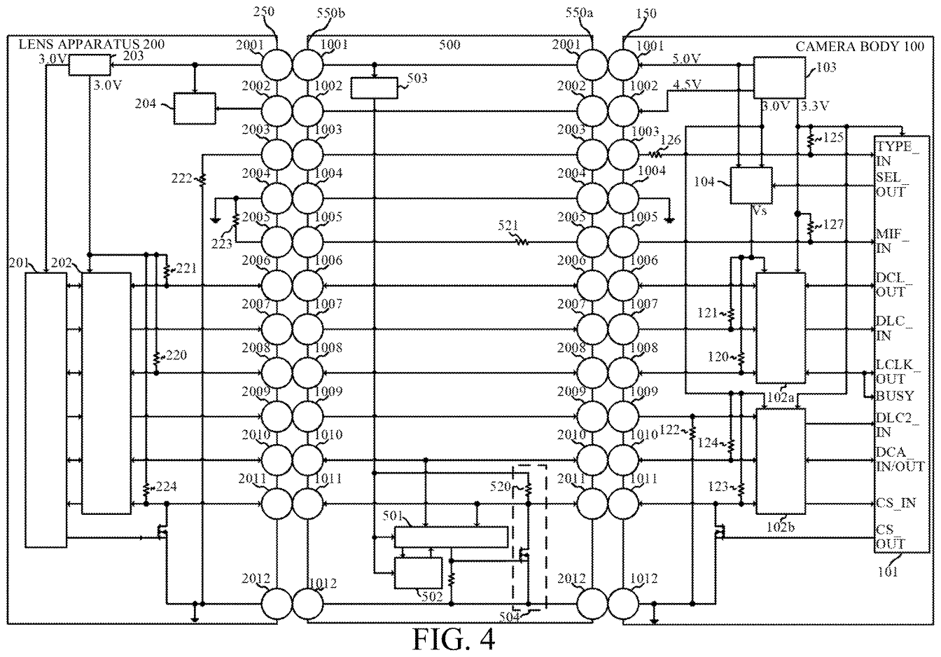

Next, with reference to FIG. 4, a case where the lens apparatus 200 is attached to the camera body 100 via the intermediate accessory apparatus 500 will be described. The intermediate accessory apparatus 500 can perform the third communication with the camera body 100.

FIG. 4 is a block diagram of the case where the lens apparatus 200 is attached to the camera body 100 via the intermediate accessory apparatus 500. As described above, the intermediate accessory apparatus 500 includes the mount portions 550a and 550b. The intermediate accessory apparatus 500 further includes an accessory control unit 501 that controls communication with the camera body 100 and performs processing in accordance with an operation of an operation member (not illustrated) provided in the intermediate accessory apparatus 500. The operation of the operation member is transmitted to the accessory control unit 501 via an accessory operation input unit 502. An example of the operation member is a function ring capable of setting an aperture value.

The mount portion 550a is the same as the mount portion 250 of the lens apparatus 200 described above. The mount portion 550b is the same as the mount portion 150 of the camera body 100 described above. The electrical contacts 2001 to 2012 provided in the mount portion 550a are wired up to the electrical contacts 1001 to 1012 provided in the mount portion 550b in the intermediate accessory apparatus 500.

In the intermediate accessory apparatus 500, the VDD terminal 2001 is also connected to an accessory power supply unit 503 and is configured to supply power also to the intermediate accessory apparatus 500. In the present embodiment, the accessory power supply unit 503 generates a 3.0 V power supply and supplies the generated power to the accessory control unit 501 and the accessory operation input unit 502. In the intermediate accessory apparatus 500, the DCA terminal 2010 and the CS terminal 2011 used for the third communication are also connected to the accessory control unit 501, and the intermediate accessory apparatus 500 and the camera body 100 can perform third communication.

In a case where the lens apparatus 200 is attached to the camera body 100 via the intermediate accessory apparatus 500, the interface voltages of the first communication I/F unit 102a and the second/third-communication I/F unit 102b are set to 3.0 V. The interface voltage of the lens-side communication I/F unit 202 is also set to 3.0 V.

The above describes a case where the lens apparatus 200 is attached to the camera body 100.

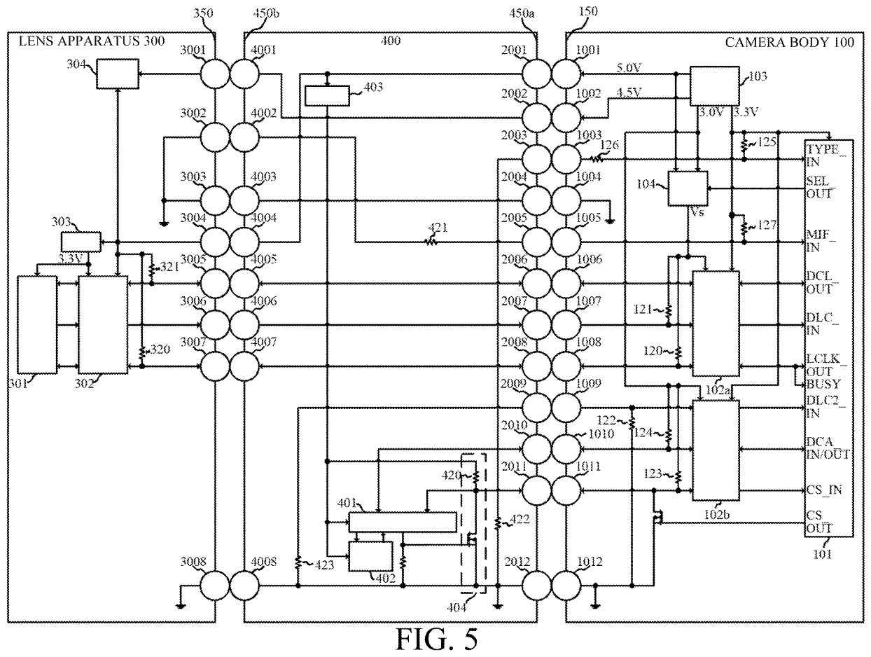

Next, with reference to FIG. 5, a case where the lens apparatus 300 is attached to the camera body 100 will be described. As described above, the lens apparatus 300 is a lens apparatus according to prior art and differs from the lens apparatus 200 according to the present embodiment. The lens apparatus 300 cannot perform the second communication or the third communication with the camera body, but can perform the first communication. The intermediate accessory apparatus 400 can perform the third communication with the camera body.

FIG. 5 is a block diagram of a case where a lens apparatus 300 is attached to the camera body 100 via an intermediate accessory apparatus 400. As described above, the intermediate accessory apparatus 400 includes the mount portions 450a and 450b. The intermediate accessory apparatus 400 further includes an adapter control unit 401 that communicates with the camera body 100 and performs processing in accordance with operation of an operation member (not illustrated). The operation of the operation member is transmitted to the adapter control unit 401 via an adapter operation input unit 402.

The mount portion 450a is similar to the mount portion 250 of the lens apparatus 200 described above. However, an internal circuit of the intermediate accessory apparatus 400 differs from an internal circuit of the lens apparatus 200. More specifically, the DCL terminals 2006, a DLC terminal 2007, and an LCLK terminal 2008 used for the first communication are not connected to the adapter control unit 401 in the intermediate accessory apparatus 400 and are through-wired to corresponding electrical contacts of the mount portion 450b. On the other hand, the DCA terminal 2010 and the CS terminal 2011 used for third communication are connected to the adapter control unit 401 in the intermediate accessory apparatus 400. This is because the intermediate accessory apparatus 400 does not perform first communication with the camera body 100, but performs third communication.

The DLC2 terminal 2009 used for second communication is pulled down, in the intermediate accessory apparatus 400, to the same level as a DGND terminal 2012 via a resistor 423. This is because the lens apparatus 300 and the camera body 100 do not perform second communication.

The TYPE terminal 2003 is pulled down, in the intermediate accessory apparatus 400, to the same level as the DGND terminal 2012 via a resistor 422. The resistor 422 has a resistance value different from that of the resistor 222 of the lens apparatus 200.

Next, the electrical contacts provided in the mount portions 450b and 350 will be described.

The electrical contacts 3001 and 4001 are terminals used to supply drive power from a VBAT terminal 1002 of the camera body 100 to the lens apparatus 300. In the intermediate accessory apparatus 400, a VBAT terminal 2002 is through-wired to the electrical contact 4001. Hereinafter, the electrical contacts 3001 and 4001 are also referred to as VBAT terminals 3001 and 4001. In the present embodiment, the voltage of power supplied to the lens apparatus 300 by the VBAT terminal 1002 is 4.5 V.

The electrical contacts 3004 and 4004 are terminals used to supply communication power from a VDD terminal 1001 of the camera body 100 to the lens apparatus 300. In the intermediate accessory apparatus 400, a VDD terminal 2001 is through-wired to the electrical contact 4004 and is also connected to an adapter power supply unit 403 in the intermediate accessory apparatus 400. The adapter power supply unit 403 generates a 3.0 V power supply as a power supply to be provided to the adapter control unit 401 and the adapter operation input unit. Hereinafter, the electrical contacts 3004 and 4004 are also referred to as VDD terminals 3004 and 4004. In the present embodiment, the voltage of power supplied to the lens apparatus 200 by the VDD terminal 1001 is 5.0 V.

The electrical contacts 3003 and 4003 are terminals for connecting a drive system of the camera body 100 and the lens apparatus 300 to ground, i.e., grounding terminals corresponding to the VBAT terminals. In the intermediate accessory apparatus 400, a PGND terminal 2004 is through-wired to the electrical contact 4003. Hereinafter, the electrical contacts 3003 and 4003 are also referred to as PGND terminals 3003 and 4003.

The electrical contacts 3008 and 4008 are terminals for connecting a communication control system of the camera body 100 and the lens apparatus 300 to ground, i.e., grounding terminals corresponding to the VDD terminals. In the intermediate accessory apparatus 400, the VDD terminal 2012 is through-wired to the electrical contact 4008. Hereinafter, the electrical contacts 3008 and 4008 are also referred to as DGND terminals 3008 and 4008.

The electrical contacts 3002 and 4002 are terminals used to detect that the lens apparatus 300 has been attached to the camera body 100 via the intermediate accessory apparatus 400. When the camera control unit 101 detects the attachment of the lens apparatus 300, the camera control unit 101 starts supplying power to the lens apparatus 300. In the intermediate accessory apparatus 400, an MIF terminal 2005 is through-wired to the electrical contact 4002. Hereinafter, the electrical contacts 3002 and 4002 are also referred to as MIF terminals 3002 and 4002.

The electrical contacts 3005 to 3007 and 4005 to 4007 are terminals used for the first communication described later. Input/output of the electrical contacts 3005 to 3007 is controlled by a lens control unit 301 via a lens-side communication I/F unit 302. Hereinafter, the electrical contacts 3005, 3006, and 3007 are also referred to as a DCL terminal 3005, a DLC terminal 3006, and an LCLK terminal 3007, respectively. The electrical contacts 4005, 4006, and 4007 are also referred to as a DCL terminal 4005, a DLC terminal 4006, and an LCLK terminal 4007, respectively.

In a case where the lens apparatus 300 is attached via the intermediate accessory apparatus 400, an interface voltage of the first communication I/F unit 102a and an interface voltage of the lens-side communication I/F unit 302 are set to 5.0 V (a second voltage), which is the same as the voltage supplied from the VDD terminals. The second voltage is different from the first voltage.

On the other hand, an interface voltage of the second/third-communication I/F unit 102b is set to 3.0 V. That is, in a case where the lens apparatus 300 is attached to the camera body 100 via the intermediate accessory apparatus 400, the communication voltage for first communication and the communication voltage for third communication are different from each other. As described later, in a case where the lens apparatus 300 is attached to the camera body 100 via the intermediate accessory apparatus 400, the second communication is not performed.

The configurations of the camera body 100 and the accessory apparatus attachable to the camera body 100 have been described above. Next, a function of the TYPE terminal 1003 will be described in detail.

Hereinafter, it is assumed that a power supply voltage to which the TYPE terminal 1003 is pulled up in the camera body is 3.3 V. It is also assumed that a resistance value of the resistor 125 is 100 kΩ, a resistance value of a resistor 126 is 1 kΩ, a resistance value of the resistor 222 is 33 kΩ, and a resistance value of the resistor 422 is 300 kΩ. It is also assumed that a voltage value input to a TYPE_IN terminal is converted into a digital signal with 10-bit resolution by an A/D converter (not illustrated).

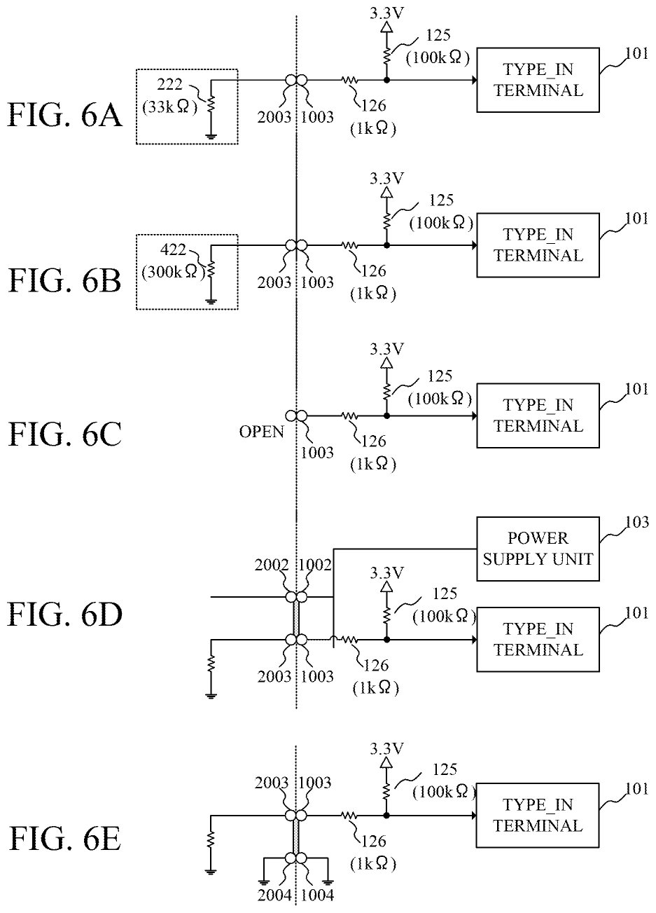

FIG. 6A illustrates a peripheral circuit of the TYPE terminal 1003 while the lens apparatus 200 is attached to the camera body 100. In this case, a value input to the TYPE_IN terminal of the camera control unit 101 is a value obtained by A/D-converting a voltage value obtained by dividing the power supply voltage (3.3 V) by the resistor 125 and the resistor 222, and is approximately “0x0103”.

FIG. 6B illustrates a peripheral circuit of the TYPE terminal 1003 while the lens apparatus 300 is attached to the camera body 100 via the intermediate accessory apparatus 400. In this case, a value input to the TYPE_IN terminal of the camera control unit 101 is a value obtained by A/D-converting a voltage value obtained by dividing the power supply voltage (3.3 V) by the resistor 125 and the resistor 422, and is approximately “0x0300”.

By making the resistance value of the resistor 422 of the intermediate accessory apparatus 400 different from the resistance value of the resistor 222 of the lens apparatus 200, the value input to the TYPE_IN terminal can be made different according to the type of the accessory apparatus attached to the camera body 100. The camera control unit 101 can identify the type of the accessory apparatus attached to the camera body 100 using the input value of the TYPE_IN terminal.

However, if any abnormality occurs in a connection state between the TYPE terminals 1003 and 2003, a value not originally assumed may be input to the TYPE_IN terminal in some cases. If the camera control unit 101 determines that some accessory apparatus is attached to the camera body 100 despite the presence of some abnormality in the attachment state of the accessory apparatus, an out-of-rating voltage may be applied to the accessory apparatus. Accordingly, with reference to FIGS. 6C, 6D, and 6E, a case where any abnormality occurs in the connection state between the TYPE terminals 1003 and 2003 will be considered.

FIG. 6C illustrates a peripheral circuit of the TYPE terminal 1003 in a case where, although the attachment of the accessory apparatus to the camera body 100 has been completed, the TYPE terminals 1003 and 2003 do not contact each other due to poor contact or the like. In this case, a voltage value input to the TYPE_IN terminal is determined only by the resistor 125 (100 kΩ) in the camera body 100, and a value after A/D conversion is approximately “0x03FF”.

FIG. 6D illustrates a peripheral circuit of the TYPE terminal 1003 in a case where the TYPE terminal 1003 and the VBAT terminal 1002 are short-circuited. Here, consider a case where the determination of the type of the accessory apparatus attached to the camera body 100 is performed before power is supplied to the VBAT terminals 1002 and 2002. If the voltage of the VBAT terminals 1002 and 2002 when power is not supplied is the same as that of the PGND terminal and the TYPE terminal 1003 and the VBAT terminal 1002 are short-circuited, the voltage of the TYPE terminal 1003 becomes approximately equal to the voltage of the PGND terminal. At this time, a value input to the TYPE_IN terminal is determined by the voltage division ratio between the resistor 125 (100 kΩ) and the resistor 126 (1 kΩ) in the camera body 100 and is approximately “0x000A”.

Next, consider a case where the determination of the type of accessory apparatus attached to the camera body 100 is performed after power is supplied to the VBAT terminal 1002 and the VBAT terminal 2002. In this case, if the TYPE terminal 1003 and the VBAT terminal 1002 are short-circuited, the VBAT voltage (4.5 V in the present embodiment) is applied to the TYPE terminal 1003. At this time, a value input to the TYPE_IN terminal is approximately “0x03FF”.

FIG. 6E illustrates a peripheral circuit of the TYPE terminal 1003 in a case where the TYPE terminal 1003 and the PGND terminal 1004 are short-circuited. In a case where the TYPE terminal 1003 and the PGND terminal 1004 are short-circuited, the voltage of the TYPE terminal 1003 becomes approximately equal to the voltage of the PGND terminal 1004 (a reference potential voltage of the VBAT voltage). At this time, a value input to the TYPE_IN terminal is determined by a voltage division ratio between the resistor 125 (100 kΩ) and the resistor 126 (1 kΩ) in the camera body 100 and is approximately “0x000A”.

As described above, in a case where any abnormality occurs in the connection state between the TYPE terminals 1003 and 2003, the voltage of the TYPE terminal 1003 becomes approximately equal to the VBAT voltage or the voltage of the PGND terminal 1004. Accordingly, in the present embodiment, a voltage range that does not include the VBAT voltage or the voltage of the PGND terminal 1004 is set as a voltage range of the TYPE terminal 1003 for which it is determined that the lens apparatus is properly attached to the camera body 100. Table 1 is a correspondence table between an input value of the TYPE_IN terminal in the present embodiment and a determination result of the attachment state by the camera control unit 101.

TABLE 1

| TYPE_IN | 0x0000~0x007F | 0x0080~0x017F | 0x0180~0x027F | 0x0280~0x037F | 0x0380~0x03FF |
|---|---|---|---|---|---|
| Determination | Error | Lens Apparatus | — | Lens Apparatus | Error |
| Result | | 200 | | 300 | |
| Communication | — | 3.0 V | — | 5.0 V | — |
| Voltage | | | | | |

As illustrated in Table 1, if an input value of the TYPE_IN terminal is within a range of “0x0080 to 0x017F”, the camera control unit 101 determines that the lens apparatus 200 is attached to the camera body 100. “0x0080 to 0x017F” does not include a input value of the TYPE_IN terminal in a case where the voltage of the TYPE terminal 1003 is the VBAT voltage or the voltage of the PGND terminal 1004. Thus, only in a case where the lens apparatus 200 is properly attached to the camera body 100, the camera control unit 101 can determine that the lens apparatus 200 is attached to the camera body 100. In a case where it is determined that the lens apparatus 200 is attached, the camera control unit 101 performs communication with the lens apparatus 200 at the communication voltage of 3.0 V.

Similarly, if an input value of the TYPE_IN terminal is within a range of “0x0280 to 0x037F”, the camera control unit 101 determines that the lens apparatus 300 is attached to the camera body 100. “0x0280 to 0x037F” does not include an input value of the TYPE_IN terminal in a case where the voltage of the TYPE terminal 1003 is the VBAT voltage or the voltage of the PGND terminal 1004. Therefore, only when the lens apparatus 300 is properly attached to the camera body 100, the camera control unit 101 can determine that the lens apparatus 300 is attached to the camera body 100. In a case where it is determined that the lens apparatus 300 is attached, the camera control unit 101 performs communication with the lens apparatus 300 at the communication voltage of 5.0 V.

Thus, by previously defining a correspondence between an input value of the TYPE_IN terminal and a determination result of the attachment state by the camera control unit 101, the type of the attached lens apparatus can be properly identified.

In a case where the input value of the TYPE_IN terminal is within a range of “0x0000 to 0x007F”, the camera control unit 101 determines that some abnormality has occurred in the attachment state between the camera body 100 and the accessory apparatus. “0x0000 to 0x007F” includes the input value of the TYPE_IN terminal “0x000A” in a case where the voltage of the TYPE terminal 1003 is approximately equal to the voltage of the PGND terminal 1004. In this case, the camera control unit 101 does not communicate with the lens apparatus attached to the camera body. Thereby, in a case where an abnormality occurs in a connection state of the TYPE terminal, it is possible to prevent an out-of-rating voltage from being applied to the accessory apparatus.

In a case where the input value of the TYPE_IN terminal is within a range of “0x0380 to 0x03FF”, the camera control unit 101 determines that some abnormality has occurred in the attachment state between the camera body 100 and the accessory apparatus. “0x0380 to 0x03FF” includes the input value of the TYPE_IN terminal “0x03FF” in a case where the voltage of the TYPE terminal 1003 is approximately equal to the VBAT voltage. In this case, the camera control unit 101 does not communicate with the lens apparatus attached to the camera body. Thereby, in a case where an abnormality occurs in a connection state of the TYPE terminal, it is possible to prevent an out-of-rating voltage from being applied to the accessory apparatus.

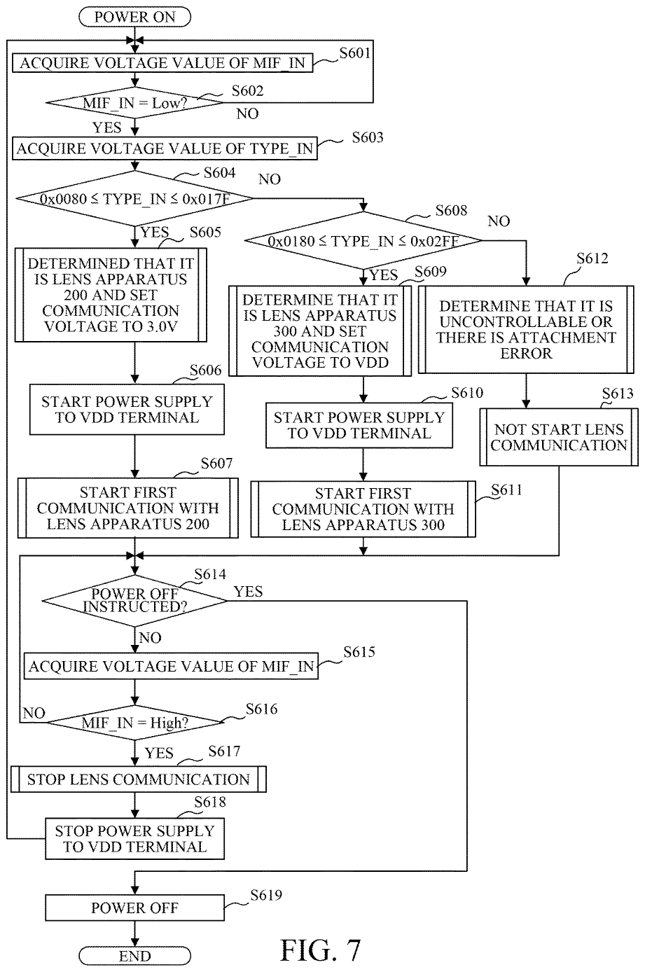

Next, with reference to FIG. 7, an operation flow of the camera body 100 will be described. FIG. 7 is a flowchart illustrating an operation of the camera body 100. This flow is executed in accordance with a computer program stored in the camera control unit 101. The flowchart of FIG. 7 starts from a state where the camera body 100 is powered on by operation of a power switch (not illustrated) of the camera body 100.

First, in step S601, the camera control unit 101 acquires a voltage value of an MIF_IN terminal and stores the voltage value in a RAM area (not illustrated).

Next, in step S602, the camera control unit 101 determines whether or not the voltage value of the MIF_IN terminal stored in step S601 corresponds to a low level. In a case where the voltage value of the MIF_IN terminal is not at the low level, since no lens apparatus is attached to the camera body 100, the flow returns to step S601 (No in step S602). In a case where the voltage value of the MIF_IN terminal is at the low level, the camera control unit 101 determines that a lens apparatus is attached to the camera body 100, and the flow proceeds to step S603.

In step S603, the camera control unit 101 acquires a voltage value of TYPE_IN and stores the voltage value in a RAM area (not illustrated).

In step S604, the camera control unit 101 determines whether or not the TYPE_IN value stored in step S603 is within a range of 0x0080 or more and 0x017F or less. In a case where step S604 is Yes, the camera control unit 101 determines that the attached lens apparatus is the lens apparatus 200. In this case, the flow proceeds to step S605.

In step S605, the camera control unit 101 controls the power switching unit 104 such that a power supply voltage supplied to the first communication I/F unit 102a becomes 3.0 V.

Thereafter, in step S606, the power supply by the camera power supply unit 103 to the VDD terminal 1001 is started, and in step S607, the communication with the lens apparatus 200 by the first communication is started.

On the other hand, if step S604 is No, the flow proceeds to step S608. In step S608, the camera control unit 101 determines whether the TYPE_IN value stored in step S603 is within a range of 0x0180 or more and 0x02FF or less. In a case where step S608 is Yes, the camera control unit 101 determines that the attached lens apparatus is the lens apparatus 300. In this case, the flow proceeds to step S609.

In step S609, the camera control unit 101 controls the power switching unit 104 such that a power supply voltage supplied to the first communication I/F unit 102a becomes 5.0 V.

Thereafter, in step S610, the power supply from the camera power supply unit 103 to the VDD terminal 1001 is started, and in step S611, the communication with the lens apparatus 300 by the first communication is started.

On the other hand, in a case where step S608 is No, the flow proceeds to step S612. In this case, the camera control unit 101 determines that the attached accessory apparatus is an accessory apparatus that cannot be controlled by the camera body 100 or that an abnormality has occurred in the attachment state, and the flow proceeds to step S613.

In step S613, the camera control unit 101 does not communicate with the accessory apparatus and displays that a connection error has occurred on a display unit (not illustrated) provided in the camera body 100.

In step S614, it is determined whether or not the camera body 100 has been powered off by the operation of the power switch of the camera body 100. In a case where it is determined that the power switch has been turned off, power-off processing is performed in step S619. Otherwise, the flow proceeds to step S615.

In step S615, the camera control unit 101 reads a voltage value of the MIF_IN terminal and stores the voltage value in a RAM area (not illustrated).

In step S616, the camera control unit 101 determines whether the voltage value of MIF_IN stored in step S615 corresponds to a high level. In a case where the voltage value of MIF_IN is high, it is determined that the lens apparatus attached to the camera body 100 has been removed. On the other hand, in a case where the voltage value of MIF_IN is at a low level, it is determined that the lens apparatus remains attached, and the flow returns to step S614.

In step S617, the camera control unit 101 stops communication with the lens apparatus, and in step S618, the camera control unit 101 stops power supply from the camera power supply unit 103 to the VDD terminal 1001. Thereafter, the flow proceeds to step S601.

A description will now be given of the communication between the accessory apparatus attached to the camera body 100 and the camera body 100.

First, the first communication will be described. The first communication is one of the communications performed between the camera body 100 and a lens apparatus attached to the camera body 100. The first communication is performed using the LCLK terminal, the DCL terminal, and the DLC terminal. The first communication is performed by a clock-synchronous communication method. The first communication may be performed by an asynchronous communication method. In that case, the LCLK terminal is used as a terminal for notifying the lens apparatus of a data transmission request from the camera body 100.

Both the lens apparatus 200 and the lens apparatus 300 support the first communication. However, as described above, the communication voltage of the first communication differs between the lens apparatus 200 and the lens apparatus 300.

The camera body 100 transmits, to the lens apparatus, control commands for controlling the lens apparatus by the first communication. The control commands include commands for driving a drive unit (not illustrated) of the lens apparatus. Examples of the drive unit of the lens apparatus include a focus lens, a zoom lens, and an aperture blade.

The lens apparatus that has received the control commands transmitted by the first communication performs operations in accordance with the commands. The lens apparatus also transmits information (state information) regarding its own state in response to the control commands to the camera body 100 by the first communication. The state information herein includes information on a position of the focus lens, a focal length, and an aperture value.

As described above, the first communication is communication mainly used for controlling the lens apparatus.

Next, the second communication will be described. The second communication is one of communications performed between the camera body 100 and the lens apparatus 200 attached to the camera body 100, and is asynchronous communication performed using DLC2 terminals 1009 and 2009. Since the lens apparatus 300 does not have a DLC2 terminal, the second communication is not performed when the lens apparatus 300 is attached to the camera body 100. Hence, in a case where the lens apparatus 300 is attached to the camera body 100, the DLC2 terminal 1009 is not used.

In the second communication, the lens apparatus 200 serves as a communication master and transmits optical data such as a focus lens position, a zoom lens position, an aperture value, and a state of an image stabilization lens in the lens apparatus 200 to the camera body 100. The types and order of data to be transmitted from the lens apparatus 200 to the camera body 100 by the second communication are specified by the camera body 100 by the first communication.

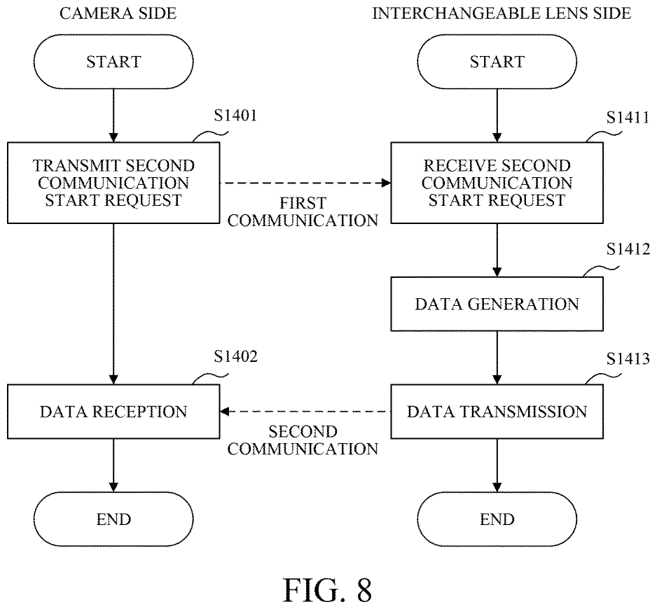

Here, with reference to FIG. 8, a flow of the second communication will be described. FIG. 8 is a flowchart illustrating the second communication. The flowchart of FIG. 8 starts from a timing at which imaging control is started.

In step S1401, the camera body 100 transmits a start request requesting that the second communication be started to the lens apparatus 200 using the first communication. The start request transmitted in step S1401 includes a registered communication command in which a type of data to be received from the lens apparatus 200 by the camera body 100 in the second communication and an order of reception are registered in advance.

In step S1411, the lens apparatus 200 receives the start request from the camera body 100. In step S1412, the lens apparatus 200 generates, in a specified order, data of the type specified by the registered communication command included in the start request.

In step S1413, the lens apparatus 200 transmits the data generated in step S1412 to the camera body 100 using the second communication. That is, the lens apparatus 200 transmits the data generated in step S1412 to the camera body 100 using the DLC2 terminal 2009.

In step S1402, the camera body 100 receives the data transmitted by the second communication from the lens apparatus 200.

In a case where imaging control is started again after step S1402 or S1413, the control illustrated in FIG. 8 is started again.

Thus, the start request for the second communication is made by the first communication, and data transmission from the lens apparatus 200 to the camera body 100 by the second communication is performed using the DLC2 terminal 2009. Therefore, by providing the DLC2 terminal 2009 separately from electrical contacts used for the first communication and performing the second communication, optical data can be transmitted from the lens apparatus 200 to the camera body 100 without interfering with other communication that needs to be performed in the first communication.

Since the start request for the second communication is made by the first communication, the second communication cannot be performed in a case where the first communication is not established.

Next, the third communication will be described. The third communication is communication performed between the camera body 100 and the lens apparatus 200, the intermediate accessory apparatus 400, and the intermediate accessory apparatus 500, and is asynchronous communication performed using DCA terminals and CS terminals.

As described above, since the lens apparatus 300 does not include DCA terminals or CS terminals, when the lens apparatus 300 is attached to the camera body 100 via the intermediate accessory apparatus 400, the camera body 100 and the lens apparatus 300 do not perform the third communication. However, in this case, the camera body 100 and the intermediate accessory apparatus 400 may perform the third communication.

In the third communication, a communication master is the camera body 100, and communication slaves are the lens apparatus 200, the intermediate accessory apparatus 400, and the intermediate accessory apparatus 500. Although FIG. 4 illustrates an example case where only one intermediate accessory apparatus 500 is attached between the camera body 100 and the lens apparatus 200, a plurality of intermediate accessory apparatuses may be attached between the camera body 100 and the lens apparatus 200. Therefore, a plurality of communication slaves may be connected in series to one communication master in the third communication. Thus, in the third communication, communication can be performed in the broadcast communication mode in which the camera body 100 transmits signals to a plurality of slaves at once, and in the P2P communication mode in which communication is performed by specifying a particular slave.

In both the broadcast communication mode and the P2P communication mode in the third communication, the DCA terminals function as terminals for transmitting and receiving data. On the other hand, a function of the CS terminals differs between the broadcast communication mode and the P2P communication mode. Hereinafter, a function of the CS terminals in the broadcast communication mode and the P2P communication mode will be described using an example case where the lens apparatus 200 is attached to the camera body 100 via the intermediate accessory apparatus 500.

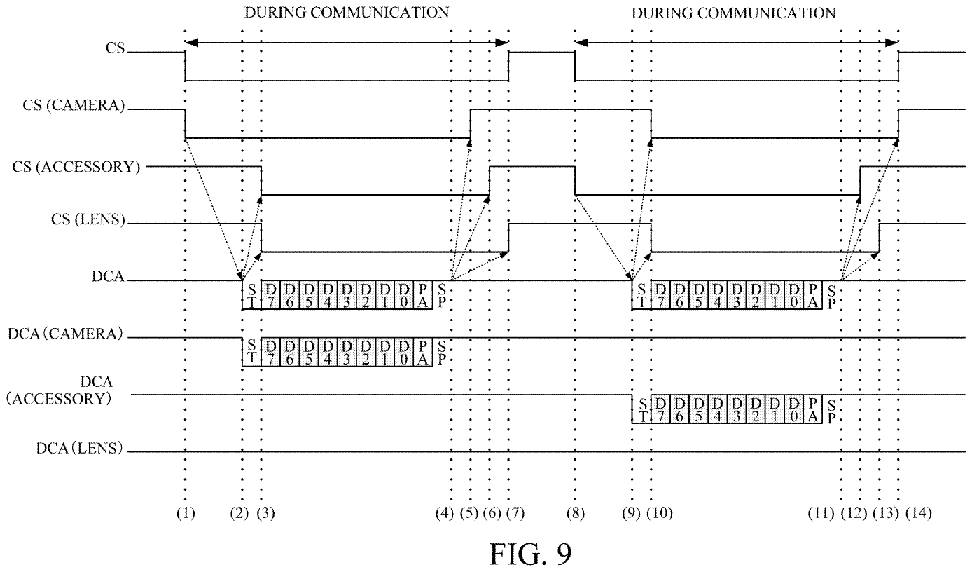

FIG. 9 is a diagram illustrating a communication control timing in the broadcast communication exchanged among the camera control unit 101, the lens control unit 201, and the accessory control unit 501. The outputs of the CS terminals of the camera control unit 101, the lens control unit 201, and the accessory control unit 501 are denoted by CS (camera), CS (lens), and CS (accessory), respectively. The outputs of the DCA terminals of the camera control unit 101, the lens control unit 201, and the accessory control unit 501 are denoted by DCA (camera), DCA (lens), and DCA (accessory), respectively. A signal waveform of a signal line formed by the CS terminals (CS signal line) and a signal waveform of a signal line formed by the DCA terminals (DCA signal line) are denoted by CS and DCA, respectively. FIG. 9 illustrates a case where the broadcast communication from the accessory control unit 501 to the camera control unit 101 and the lens control unit 201 is performed in response to the broadcast communication from the camera control unit 101 to the lens control unit 201 and the accessory control unit 501.

First, at timing (1) illustrated in FIG. 9, the camera control unit 101 serving as the communication master outputs a low level signal to the CS terminal to notify the lens control unit 201 and the accessory control unit 501 serving as communication slaves that the broadcast communication is to be started. Next, at timing (2) illustrated in FIG. 9, the camera control unit 101 outputs data to be transmitted to the DCA terminal.

At timing (3) in FIG. 9, when the lens control unit 201 and the accessory control unit 501 detect a start bit ST of a signal input from the DCA terminal, the lens control unit 201 and the accessory control unit 501 start outputting low level signals to their CS terminals. At this point, since the camera control unit 101 has already output a low level signal to its CS terminal at timing (1), the level of the CS signal line does not change.

At timing (4) in FIG. 9, in a case where an output up to a stop bit SP of the data to be transmitted is completed, the camera control unit 101 releases a low level output to the CS terminal at timing (5). On the other hand, after receiving the stop bit SP, the lens control unit 201 and the accessory control unit 501 analyze the received data and perform internal processing related to the received data. When the internal processing is completed and preparations for receiving the next data are ready, the lens control unit 201 and the accessory control unit 501 release the low level output to their CS terminals at timings (6) and (7), respectively.

Here, a time required for analyzing the received data and performing the internal processing related to the received data differs according to processing capability of each control unit. Therefore, in order to properly perform the subsequent communication, each control unit may grasp a timing at which the internal processing related to the received data has been completed in all other microcomputers.

In the present embodiment, as described above, the CS terminals are open-type output terminals. Therefore, the level of the CS signal line becomes high when all of the camera control unit 101, the lens control unit 201, and the accessory control unit 501 have released their low level outputs to the CS terminals. That is, each control unit involved in the broadcast communication can determine that other control units are ready for the next communication by confirming that the level of the CS signal line becomes high, and thus can properly perform the next communication.

At timing (8), the accessory control unit 501 starts outputting a low-level signal to the CS terminal to notify the camera control unit 101 and the lens control unit 201 that the broadcast communication is to be started. Next, at timing (9), the accessory control unit 501 outputs data to be transmitted to the DCA terminal.

When the camera control unit 101 and the lens control unit 201 detect a start bit ST input from the DCA terminal, the camera control unit 101 and the lens control unit 201 start outputting low-level signals to their CS terminals at timing (10). At this point, since the accessory control unit 501 has already started outputting a low-level signal to the CS terminal, the level of the CS signal line does not change. Next, after completing the output of the stop bit SP at timing (11), the accessory control unit 501 releases a low-level signal output to the CS terminal at timing (12).

After receiving the stop bit SP input from the DCA terminal, the camera control unit 101 and the lens control unit 201 analyze the received data and perform the internal processing associated with the received data. After the preparations for receiving the next data are ready, the camera control unit 101 and the lens control unit 201 release low-level outputs to their CS terminals at timings (13) and (14), respectively.

As described above, the CS terminals in the broadcast communication notify, by a change in voltage value, a timing to start the broadcast communication and a timing at which preparations for receiving signals have been completed in all microcomputers.

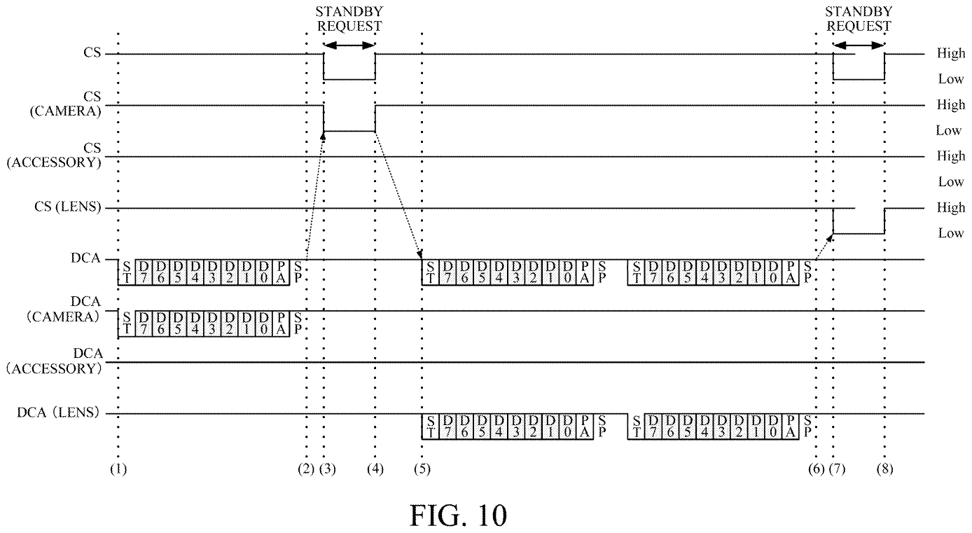

Next, the function of the CS terminals in the P2P communication will be described. FIG. 10 is a diagram illustrating a communication control timing of the P2P communication exchanged among the camera control unit 101, the lens control unit 201, and the accessory control unit 501. Here, an example is illustrated in which the camera control unit 101 transmits one byte of data to the lens control unit 201 and, in response to the data, the lens control unit 201 transmits two bytes of data to the camera control unit 101.

First, the camera control unit 101 transmits an instruction to transmit particular data to the lens control unit 201 at timing (1) illustrated in FIG. 10 using the DCA terminal. After timing (2) at which the output up to a stop bit SP is completed, at timing (3), the camera control unit 101 starts outputting a low-level signal to the CS terminal. While outputting the low-level signal to the CS terminal, the camera control unit 101 prepares for receiving data, and when it is ready at timing (4), the camera control unit 101 releases the low output to the CS terminal.

On the other hand, after detecting the low-level signal of the CS terminal output by the camera control unit 101, the lens control unit 201 analyzes the instruction received from the camera control unit 101 and performs the internal processing related to the instruction. After confirming that the low output to the CS terminal has been released, the lens control unit 201 transmits data corresponding to the instruction received from the camera control unit 101 from the DCA terminal at timing (5). After completing the output up to a stop bit SP of the second byte at timing (6), the lens control unit 201 starts outputting the low-level signal to the CS terminal at timing (7).

Thereafter, at timing (8) when preparations for receiving the next data are ready, the lens control unit 201 releases the low output to the CS terminal. The accessory control unit 501 not specified as a communication counterpart in the P2P communication does not participate at all in operation of the CS signal line and the DCA signal line.

As described above, in the P2P mode, the CS terminals notify, by a change in voltage value, a timing at which data transmission is completed at the data-transmitting apparatus and a timing at which preparation for receiving data is completed at the data-receiving apparatus.

As described above, in the third communication, the CS terminals have different functions between the broadcast communication mode and the P2P mode. Thus, the broadcast communication mode and the P2P mode are achieved using only two signal lines. The transmission and reception of data in the third communication are performed by the DCA terminals whose input/output interfaces are of the CMOS type. Therefore, even if the output interface of the CS terminals used simply to notify a variety of timings in the third communication is of the open type, high-speed communication can be achieved.

Next, the communication voltages of the first to third communications will be described. As described above, in a case where the lens apparatus 200 is attached to the camera body 100, the first communication, the second communication, and the third communication can be performed. On the other hand, in a case where the lens apparatus 300 is attached to the camera body 100, the first communication and the third communication can be performed. That is, in a case where the lens apparatus 200 is attached to the camera body 100, a larger number of types of communication are performed than in a case where the lens apparatus 300 is attached. Therefore, the communication voltage in a case where the lens apparatus 200 may be attached to the camera body 100 may be as low as possible in order to reduce power consumption. Thus, in the present embodiment, the communication voltage (3.0 V) of the first communication in a case where the lens apparatus 200 is attached is set to be lower than the communication voltage (5.0 V) in a case where the lens apparatus 300 is attached.

As in the present embodiment, by setting the communication voltage of the third communication in a case where the lens apparatus 200 is attached to be the same as the communication voltage in a case where the lens apparatus 300 is attached, the configuration of the second/third-communication I/F unit 202b can be simplified. In that case, the communication voltage of the third communication may be set equal to a lower one of the communication voltage of the first communication in a case where the lens apparatus 200 is attached and the communication voltage of the first communication in a case where the lens apparatus 300 is attached. Thereby, the power consumption in performing the third communication can be reduced.

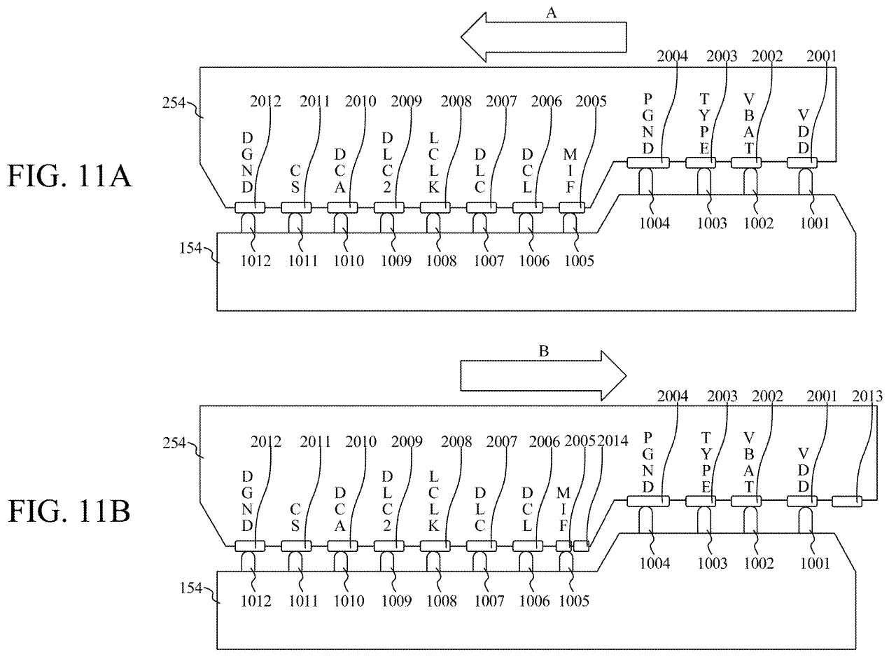

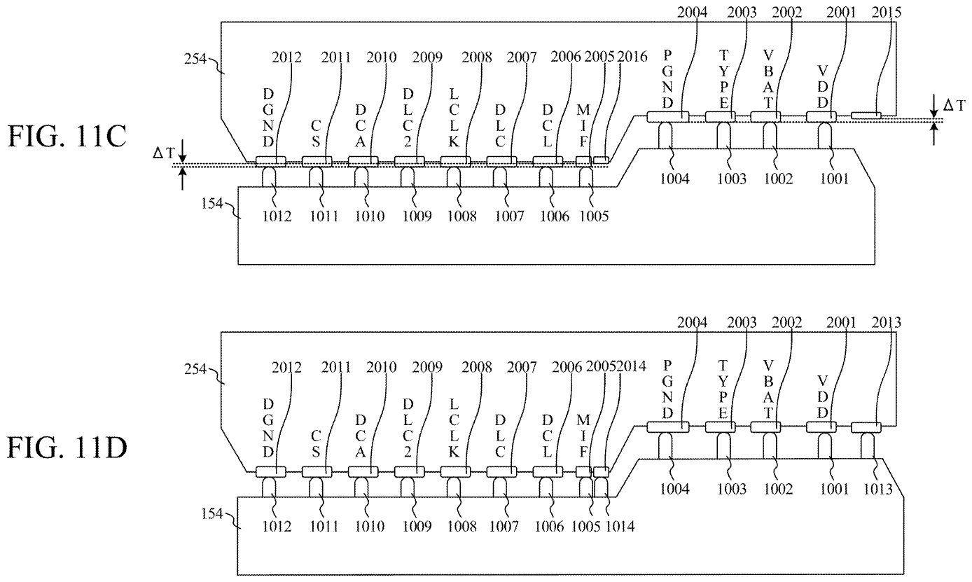

Next, with reference to FIGS. 11A, 11B, 11C, and 11D, the shapes of the camera-side contact holder 154 and the accessory-side contact holder 254 of the mount portions 150 and 250 will be described. Here, a case where the lens apparatus 200 is attached to the camera body 100 will be described as an example, but this is similarly applicable to a case where the intermediate accessory apparatus 400 or the intermediate accessory apparatus 500 is attached to the camera body 100.

FIG. 11A is a schematic diagram according to a comparative example, of the accessory-side contact holder 254 and the camera-side contact holder 154 when viewed from a direction perpendicular to the optical axis in a state where the lens apparatus 200 is attached to the camera body 100. In FIG. 11A, the camera-side contact holder 154 and the accessory-side contact holder 254 are illustrated in plan view. However, in reality, the shapes of the camera-side contact holder 154 and the accessory-side contact holder 254 are curved along a circumferential direction of the mount portions 150 and 250. The electrical contacts of the camera body 100 are each biased by an elastic member (not illustrated) in the camera-side contact holder 154, in a direction protruding from the camera-side contact holder 154. Examples of the elastic member include a coil spring and a leaf spring.

An arrow A illustrated in FIG. 11A indicates a moving direction (rotating direction) of the lens apparatus 200 relative to the camera body 100 when the lens apparatus 200 is detached from the camera body 100. When the lens apparatus 200 is detached, for example, the electrical contact 2005 sequentially contacts the electrical contacts 1005 to 1012.

FIG. 11B is a schematic diagram of the accessory-side contact holder 254 and the camera-side contact holder 154 when viewed from the direction perpendicular to the optical axis while the accessory-side contact holder 254 holds electrical contacts (second terminal portions) 2013 and 2014 in addition to electrical contacts 2001 to 2012.

An arrow B illustrated in FIG. 11B indicates a moving direction (rotating direction) of the lens apparatus 200 relative to the camera body 100 when the lens apparatus 200 is attached to the camera body 100. When the lens apparatus 200 is attached to the camera body 100, for example, the electrical contact 2005 is connected to the MIF terminal 1005 after contacting the electrical contacts 1012 to 1006. The electrical contact 2014 slides on the electrical contacts 1012 to 1005 when the lens apparatus 200 is attached/detached (during the attachment operation of the lens apparatus 200), and does not contact the electrical contacts when the attachment of the lens apparatus 200 has been completed. Similarly, the electrical contact 2013 slides on the electrical contacts 1004 to 1001 when the lens apparatus 200 is attached/detached (during the attachment operation of the lens apparatus 200), and does not contact the electrical contacts when the attachment of the lens apparatus 200 has been completed. Thus, in the present embodiment, the electrical contacts 2013 and 2014 contact at least some of the electrical contacts 1001 to 1012 during the attachment operation of the lens apparatus 200 to the camera body 100.

The electrical contacts may rust due to aging. If the camera body 100 and the lens apparatus 200 are connected while a resistance value of a terminal has increased due to rust, communication failure or malfunction may occur. Accordingly, when the lens apparatus 200 is attached/detached, the electrical contacts 1001 to 1012 slide on the electrical contacts 2013 and 2014 to scrape off rust, thereby achieving stable communication between the camera body 100 and the lens apparatus 200.

In the present embodiment, electrical contacts (second terminal portions) 2013 and 2015 are disposed at the most downstream end in the first stage in the attachment direction of the mount apparatus to the camera body. In the present embodiment, the electrical contacts (second terminal portions) 2014 and 2016 are disposed at the most downstream end in the second stage in the attachment direction of the mount apparatus to the camera body. However, the present embodiment is not limited to this example.

FIG. 11C is a schematic diagram of the accessory-side contact holder 254 and the camera-side contact holder 154 when viewed from the direction perpendicular to the optical axis while the electrical contacts (terminals) 2015 and 2016 are retracted toward the lens apparatus 200 (object side). In FIG. 11C, a tip (a portion protruding most toward the image side) of each of the electrical contacts 2015 and 2016 is located closer to the object side (a direction away from the camera body) than a tip of each of the electrical contacts 2001 to 2012 (retracted by a length ΔT).

When the lens apparatus 200 is attached to the camera body 100, for example, the electrical contact 2005 is connected to the MIF terminal 1005 after contacting the electrical contacts 1012 to 1006. On the other hand, since the electrical contacts 2016 and 2015 are retracted, the electrical contacts 2016 and 2015 do not slide on the camera-side electrical contacts when the lens apparatus 200 is attached/detached, and likewise do not contact the camera-side electrical contacts when the attachment of the lens apparatus 200 has been completed. Thus, in the present embodiment, the tips of the electrical contacts 2015 and 2016 are disposed closer to the object than the tips of the electrical contacts 2001 to 2012. Therefore, the electrical contacts 2015 and 2016 do not contact the electrical contacts 1001 to 1012 during the attachment operation of the lens apparatus 200 to the camera body 100.

The terminals disposed at the end of the accessory-side contact holder 254 are generally susceptible to the external electrostatic discharge and may cause noise or terminal destruction. Accordingly, by adding the electrical contacts 2015 and 2016 that do not contact the camera-side electrical contacts, i.e., are unused terminals, and allowing the unused terminals to be charged with the static electricity instead of the VDD terminal 2001 or the MIF terminal 2005, the electrical contacts 2001 to 2012 that are used terminals can be protected.

In the present embodiment, the retraction amounts (lengths ΔT) of the electrical contacts 2015 and 2016 may not the same and may be different.

In the present embodiment, the electrical contacts (terminals) 2013 to 2016 in FIGS. 11B, 11C, and 11D are Non-Connection (NC) terminals that have no electrical connection and do not perform communication between the camera body 100 and the lens apparatus 200. However, the present embodiment is not limited to this example. Each of the electrical contacts may be a ground terminal set to the same potential as the DGND terminal 2012 or the PGND terminal 2004, or may be a TYPE2 terminal having a function equivalent to that of the TYPE terminal 2003.

If the camera body 100 and the lens apparatus 200 are connected while the electrical contacts are charged, communication failure or malfunction may occur due to the static electricity. Accordingly, by using the electrical contacts 2013 to 2014 as ground terminals and sliding the electrical contacts 2013 to 2014 on the electrical contacts 1001 to 1012 when the lens apparatus 200 is attached/detached to eliminate the static electricity, stable communication between the camera body 100 and the lens apparatus 200 can be achieved.

FIG. 11D is a schematic diagram of the accessory-side contact holder 254 and the camera-side contact holder 154 when viewed from the direction perpendicular to the optical axis while the electrical contacts (inspection-apparatus-side electrical contacts) 1013 and 1014 are held in addition to the electrical contacts 1001 to 1012. The present embodiment assumes that the inspection apparatus 600 includes the camera-side contact holder 154 and the electrical contacts 1013 and 1014 are TYPE2 terminals for identification of the inspection apparatus 600. In addition, the electrical contact 2014 slides on the electrical contacts 1012 to 1005 when the lens apparatus 200 is attached/detached to the inspection apparatus 600, and contacts the electrical contact 1014 when the attachment of the lens apparatus 200 has been completed. Similarly, the electrical contact 2013 slides on the electrical contacts 1004 to 1001 when the lens apparatus 200 is attached/detached to the inspection apparatus 600, and contacts the electrical contact 1013 when the attachment of the lens apparatus 200 has been completed. Thus, in the present embodiment, in a case where the lens apparatus 200 is attached to the inspection apparatus 600, the electrical contact (first terminal) 2013 and the electrical contact (second terminal) 2014 contact predetermined terminals of the inspection apparatus 600.

In a case where the electrical contacts 2013 to 2014 are TYPE2 terminals, and the electrical contacts 2013 to 2014 are located to contact the camera-side electrical contacts when the attachment of the camera body 100 and the lens apparatus 200 has been completed, extra power consumption may occur.

Accordingly, the configuration in which the electrical contacts 2013 to 2014 do not contact the camera-side electrical contacts when the attachment between the camera body 100 and the lens apparatus 200 is completed can suppress power consumption upon attachment to the camera body 100.

As long as the electrical contacts 2014 and 1014 contact each other when the attachment of the lens apparatus 200 has been completed, the electrical contact 1014 may be retracted toward the lens apparatus 200 side similarly to the electrical contact 2016 of FIG. 11C.

The electrical contacts 2013 to 2016 may be disposed by narrowing widths of adjacent electrical contacts 2001 and 2005, or may be disposed by extending the accessory-side contact holder 254.

As illustrated in FIGS. 11A, 11B, 11C, and 11D, the present embodiment provides steps in the camera-side contact holder 154 and the accessory-side contact holder 254. Hereinafter, a step holding fewer electrical contacts will be referred to as a first step, and a step holding more electrical contacts will be referred to as a second step. That is, the second step is a step protruding toward the camera body 100 (toward the image side) from the first step.

The first step is located at a first height, and the second step is located at a second height. Here, the “height” is intended to mean a height (in a global coordinate system) relative to a common reference. In other words, it is not intended that heights from the surfaces of the respective steps differ (i.e., a reference of height differs for each step). Therefore, even if the lengths (protrusion amounts from the surface of the terminal holder) of a plurality of terminals (such as an MIF terminal and a VDD terminal) are the same, their heights are different. There may be three or more terminals having different heights.

The first height and the second height may not be exactly equal among all terminals, and may vary so long as the terminals can contact the camera-side terminals. That is, instead of providing a step on the accessory side, lengths of terminals may differ so as to correspond to a step on the camera side.

In FIGS. 11B, 11C, and 11D, the electrical contacts 2013 and 2015 are disposed adjacent to the VDD terminal 2001 and at the end (right end) of the first step, and the electrical contacts 2014 and 2016 are disposed adjacent to the MIF terminal 2005 and at the end (right end) of the second step. Here, the “end” means the most end position among the terminals, and the terminal disposed at the end is the terminal disposed at the outermost position in the circumferential direction among a plurality of terminals.

However, the present embodiment is not limited to this example. For example, in FIG. 11B, by eliminating the step, the electrical contacts 1005 to 1012 may slide on both the electrical contacts 2013 and 2014, or the shape may be adopted in which only one of the electrical contacts 2013 and 2014 is provided.

A description will now be given of an arrangement order of the electrical contacts in the camera-side contact holder 154 and the accessory-side contact holder 254.

As described above, in the present embodiment, in the second step of the camera-side contact holder 154, a PGND terminal 1004, a TYPE terminal 1003, a VBAT terminal 1002, and a VDD terminal 1001 are arranged in this order in the attachment direction of the lens apparatus 200 (in a direction of arrow B in FIG. 11B). Similarly, in the second step of the accessory-side contact holder 254, a PGND terminal 2004, a TYPE terminal 2003, a VBAT terminal 2002, and a VDD terminal 2001 are arranged in this order in the attachment direction of the lens apparatus 200 (in the direction of the arrow B in FIG. 11B).

If a conductive foreign substance is caught between the camera-side contact holder 154 and the accessory-side contact holder 254, or if electrical contacts are deformed, adjacent electrical contacts may be short-circuited. In particular, if a power-system terminal (a VDD terminal or a VBAT terminal) and a ground terminal (a PGND terminal) are short-circuited, a large current may flow in a power supply circuit. In contrast, providing another electrical contact between the power-system terminal and the ground terminal can suppress the influence on the power supply circuit due to the short circuit.

The terminal provided between the power-system terminal and the ground terminal may be a terminal whose signal level is approximately constant during the operations of the camera body 100 and the lens apparatus 200. Generally, a protection element for protecting the internal circuit of the camera body 100 during short-circuiting is provided between a terminal adjacent to the power-system terminal and the camera control unit 101. If a terminal whose signal level changes during the operations of the camera body 100 and the lens apparatus 200 is provided between the power-system terminal and the ground terminal, the wiring capacitance of the terminal increases due to the protection element. Thus, a signal waveform transmitted or received via the terminal may be affected. On the other hand, if a terminal whose signal level is approximately constant during the operations of the camera body 100 and the lens apparatus 200 is used, the influence caused by the protection element is small. Terminals whose signal levels are approximately constant during operation include the TYPE terminal and the MIF terminal. However, since the MIF terminal may be provided at the end of the first step as described later, the TYPE terminal may be provided between the power-system terminal and the ground terminal. In the present embodiment, a resistor 126 as a protection element is provided between the TYPE terminal 1003 and the camera control unit 101.

When the lens apparatus 200 is attached to the camera body 100, if another electrical contact contacts the MIF terminal 1005, the voltage level of the MIF terminal 1005 changes, and the camera control unit 101 may erroneously detect the attachment of the lens apparatus. If the attachment of the lens apparatus 200 is erroneously detected although the attachment of the lens apparatus 200 has not been completed, power supply by the power-system terminals may start, which may cause malfunction of the lens apparatus 200 or may affect an internal circuit of the lens apparatus 200. In contrast, the MIF terminal 1005 disposed as in the present embodiment can suppress the start of the power supply before the MIF terminals are connected (i.e., before the attachment of the lens apparatus 200 is completed).

A circumferential length in the mount portion 250 of the MIF terminal 2005 of the lens apparatus 200 may be shorter than those of other electrical contacts. Thereby, when the lens apparatus 200 is attached to the camera body 100, the MIF terminal 1005 is connected last among a plurality of electrical contacts. In this case, power supply from the camera body 100 to the lens apparatus 200 can be performed after the completion of the connections of other electrical contacts. In addition, when the lens apparatus 200 is detached from the camera body 100, the MIF terminal 1005 is disconnected first among the plurality of electrical contacts. In this case, when the lens apparatus 200 is detached from the camera body 100, power supply from the camera body 100 to the lens apparatus 200 can be stopped immediately. It is sufficient that the circumferential length of the MIF terminal 2005 in the mount portion 250 be shorter than those of the other electrical contacts by an amount corresponding to a central angle of 1°.

In the present embodiment, although the camera-side contact holder 154 has a step in an optical-axis direction, the accessory-side contact holder 254 may not have a step (a first step and a second step) (i.e., the accessory-side contact holder 254 may be planar in the optical-axis direction). That is, while the camera-side contact holder 154 has a step, the accessory-side contact holder 254 may not have a step. For example, instead of providing a step, the lengths of a plurality of terminals may be varied. That is, without using the driving force of a drive unit, each terminal slides on the camera-side terminal during the attachment. For example, when the mount apparatus is attached to the camera body, terminals (2005 to 2012, 2014, and 2016) to be connected to terminals (1005 to 1012 and 1014) arranged on a lower stage of the camera-side contact holder 154 may operate to extend in the optical-axis direction (toward the image side). That is, while the mount apparatus is rotated in the lens attachment direction illustrated in FIG. 11B, the terminals (2005 to 2012, 2014, and 2016) of the mount apparatus may be configured to extend toward the image side (a protrusion amount of each terminal relative to the terminal holder increases).

In such a configuration, when the accessory mount is attached to the camera mount, the terminal holder moves in the optical-axis direction. Instead of a configuration in which only each terminal protrudes, the entire terminal holder may be configured to protrude relative to a housing of the accessory mount. For example, a configuration may be adopted in which the terminal holder advances in the optical-axis direction (each terminal does not slide on the camera-side terminal during the attachment) when the lens is rotated and attached, by providing a cam follower (protrusion) on the terminal holder and a cam groove in the housing. The above modifications may be combined as appropriate.

A plurality of terminals arranged in the respective steps may not have the same height. This is because the camera-side terminals are spring-biased in the optical-axis direction, and an error in height to some extent can be absorbed.

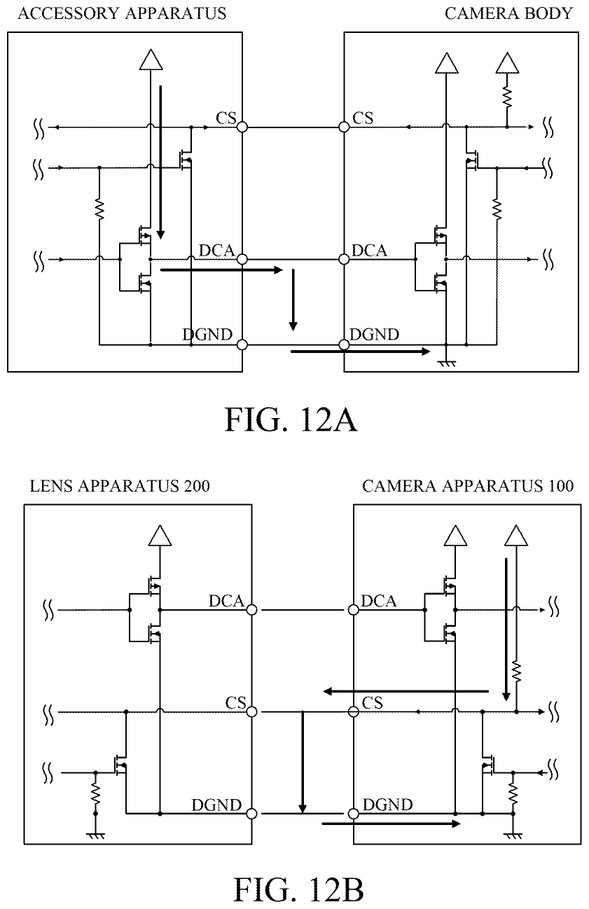

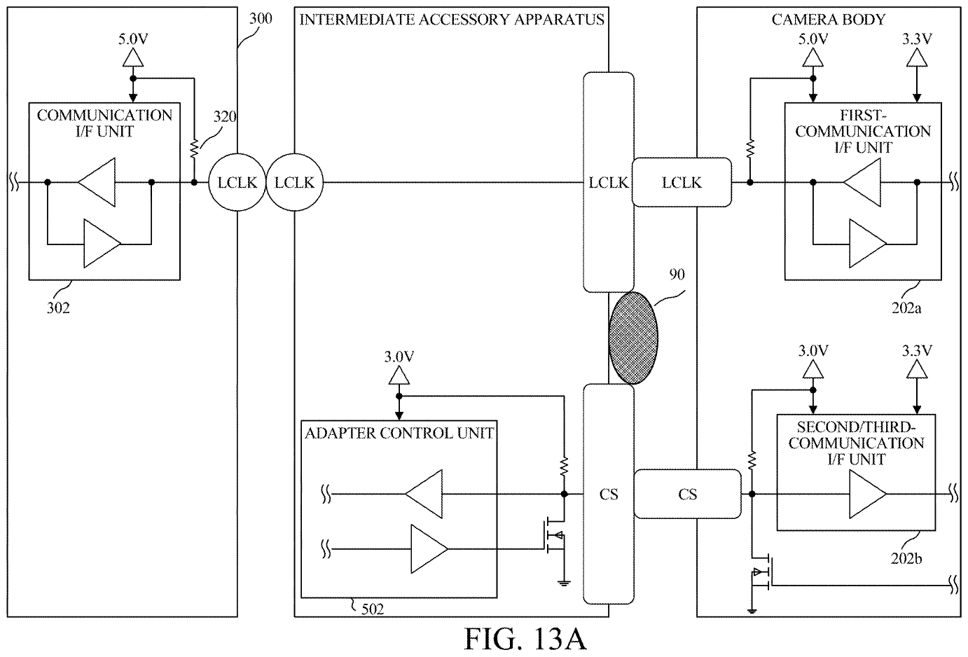

Next, with reference to FIGS. 12A and 12B, an arrangement order of the DGND terminal, the CS terminal, and the DCA terminal will be described.

First, as a comparative example, consider a case where the DCA terminal is disposed adjacent to the DGND terminal. FIG. 12A illustrates peripheral circuits of the CS terminal, the DCA terminal, and the DGND terminal in this case. As described above, the DCA terminal is a terminal of a CMOS-type input/output interface. In FIG. 12A, in a case where the DGND terminal and the DCA terminal are short-circuited due to, for example, a conductive foreign object being caught between the camera body and the accessory apparatus and a high-level signal is output to the DCA terminal, a large current flows from the DCA terminal toward the DGND terminal. This is because the resistance of the CMOS-type interface when outputting a high-level signal is low. In this case, a large current flows into the accessory apparatus and the camera body performing the third communication, and may affect the internal circuits.

On the other hand, in the present embodiment, the CS terminal is disposed between the DCA terminal and the DGND terminal. FIG. 12B illustrates peripheral circuits of the CS terminal, the DCA terminal, and the DGND terminal in the camera body 100 and the lens apparatus 200 as the accessory apparatus according to the present embodiment. As described above, the CS terminal is an open-type output terminal. Therefore, in FIG. 12B, even if the DGND terminal and the CS terminal are short-circuited, only a minute current flows into the DGND terminal. This is because the CS terminal is pulled up to a power-supply potential via a resistor.

From the above, using, as an electrical contact adjacent to the DGND terminal, the CS terminal that is an open-type output terminal can suppress the electrical influence on internal circuits of the accessory apparatus and the camera body 100 when unintended electrical contacts are connected.

In the present embodiment, the DLC2 terminal is disposed adjacent to the electrical contacts for the first communication. That is, the DLC2 terminal is disposed adjacent to the LCLK terminal. The reason will be described by comparison with a case (comparative example) in which the CS terminal or the DCA terminal is disposed in the electrical contacts for the first communication. Hereinafter, it is assumed that the lens apparatus 300 is attached to the camera body via an intermediate accessory apparatus capable of performing the third communication with the camera body. Thus, the communication voltage of the first communication is 5.0 V. The communication voltage of the third communication is 3.0 V. The second communication is not performed.

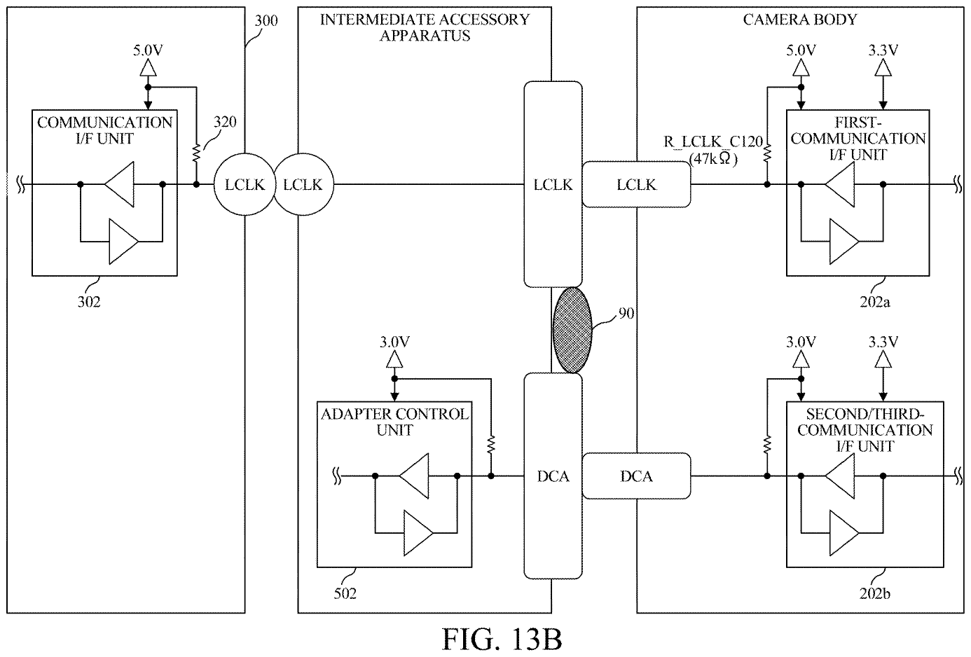

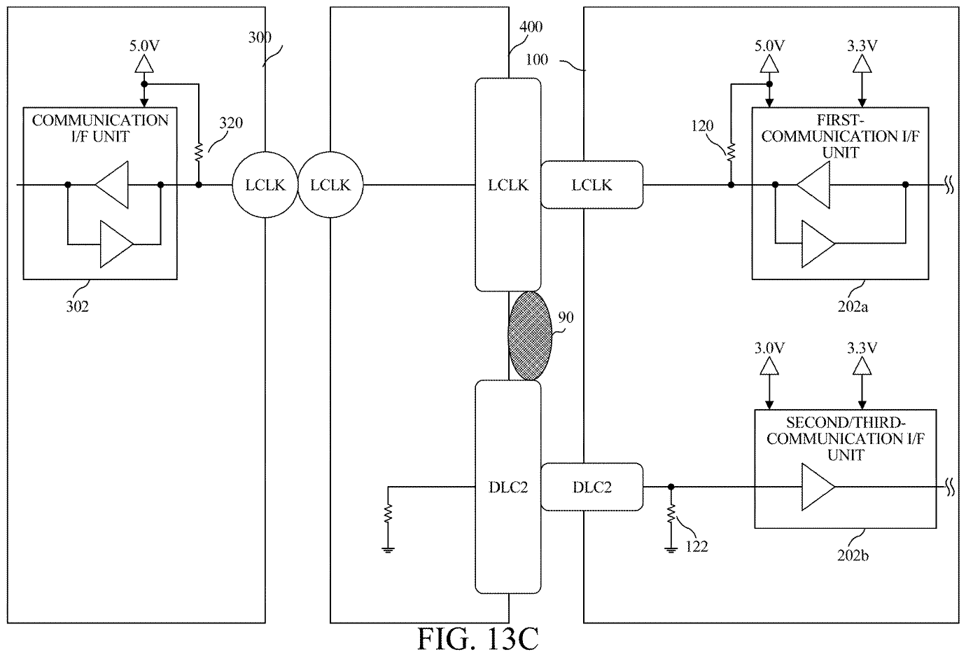

FIG. 13A illustrates peripheral circuits of the LCLK terminal and the CS terminal in a comparative example in a case where the CS terminal is disposed adjacent to the LCLK terminal. The LCLK terminal is pulled up to 5.0 V, which is the communication voltage of the first communication, in each of the camera body and the lens apparatus 300. On the other hand, the CS terminal is pulled up to 3.0 V, which is the communication voltage of the third communication, in each of the camera body and the intermediate accessory apparatus. Here, if a conductive foreign object 90 is caught between the LCLK terminal and the CS terminal and the LCLK terminal and the CS terminal are short-circuited, the voltage exceeding 3.0 V may be applied to the CS terminal. At this time, the voltage exceeding the operation voltage (3.0 V) is applied to the second/third-communication I/F unit of the camera body and an accessory control unit of the intermediate accessory apparatus.

FIG. 13B illustrates, as a comparative example, peripheral circuits of the LCLK terminal and the DCA terminal in a case where the DCA terminal is disposed adjacent to the LCLK terminal. The DCA terminal is pulled up to 3.0 V, which is the communication voltage of the third communication, in each of the camera body and the intermediate accessory apparatus. Here, if a conductive foreign object 90 is caught between the LCLK terminal and the DCA terminal and the LCLK terminal and the DCA terminal are short-circuited, the voltage exceeding 3.0 V may be applied to the DCA terminal. At this time, the voltage exceeding the operation voltage (3.0 V) is applied to the second/third-communication I/F unit of the camera body and the accessory control unit of the intermediate accessory apparatus.

FIG. 13C illustrates peripheral circuits of the LCLK terminal and the DLC2 terminal in a case where the lens apparatus 300 is attached to the camera body 100 via the intermediate accessory apparatus 400 in the present embodiment. At this time, since the second communication is not performed, the DLC2 terminal is not used. Therefore, in the present embodiment, even if the LCLK terminal and the DLC2 terminal are short-circuited, the influence on internal circuits of the camera body 100 or the intermediate accessory apparatus 400 is unlikely to occur.

In a case where the lens apparatus 200 is attached to the camera body 100, the second communication is performed, but the communication voltages of the first communication and the second communication are both 3.0 V. Therefore, even if the LCLK terminal and the DLC2 terminal are short-circuited, an excessive voltage is not applied to internal circuits of the camera body 100 or the lens apparatus 200.

Thus, an electrical contact adjacent to the electrical contacts for the first communication may be the DLC2 terminal that is not used when the lens apparatus 300 is attached.

In a case where the lens apparatus 200 is attached to the camera body 100, the second communication and the third communication may be performed simultaneously. In this case, even if the DLC2 terminal and the DCA terminal are short-circuited, since the communication voltages of the second communication and the third communication are both 3.0 V, an excessive voltage is not applied to the internal circuits of the camera body 100 or the lens apparatus 200. Therefore, the CS terminal or the DCA terminal may be disposed adjacent to the DLC2 terminal. In this case, since the DLC2 terminal is disposed between the LCLK terminal and the CS terminal or the DCA terminal, a short circuit between the LCLK terminal and the CS terminal or the DCA terminal is less likely to occur. Thereby, in a case where the lens apparatus 300 is attached to the camera body 100 via the intermediate accessory apparatus 400, it is possible to prevent a short circuit between electrical contacts that communicate at different communication voltages.

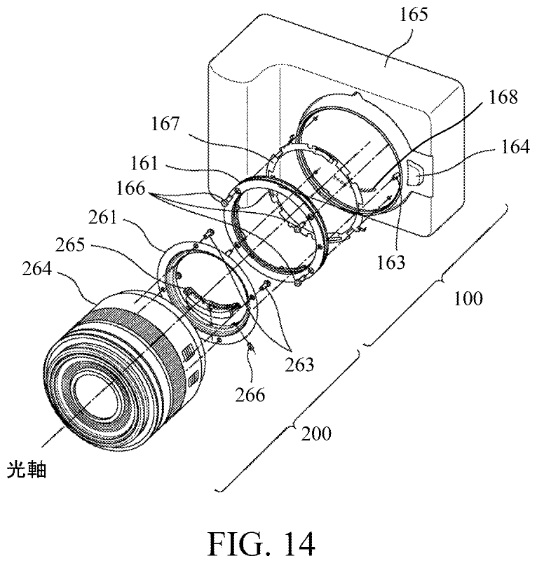

FIG. 14 is an exploded perspective view illustrating an example of mount portions of the camera body 100 and an accessory in the present embodiment. Here, the lens apparatus 200 is illustrated as an example of the accessory, but the configuration is applicable to other accessories. A camera mount 161 is fixed to a housing 165 of the camera body 100 by four screws 166 via a mount biasing member 167. The mount biasing member 167 is a member that generates a biasing force for drawing bayonet claws of a lens mount 261 described later toward the camera mount side. A camera terminal unit 168 is fixed to the housing 165 so as to be positioned inside the camera mount 161.

The housing 165 holds a lock pin 163 as a convex portion movably between a protruding position where the lock pin 163 protrudes toward the object side (lens side) from the mount surface (camera mount surface) of the camera mount 161 and a retracted position where the lock pin 163 is retracted further toward the image side. The lock pin 163 is spring-biased toward the protruding position. The camera mount 161 includes three bayonet claws at intervals in its circumferential direction. When the lens apparatus 200 is detached from the camera body 100, a user pushes a release operation member 164 provided on the camera body 100 to move the lock pin 163 from the protruding position to the retracted position.

On the other hand, a lens mount 261 is fixed to a lens barrel 264 as a housing of the lens apparatus 200 by four screws 263. The lens mount 261 has a mount surface (lens mount surface) and three bayonet claws as coupling portions at intervals in a circumferential direction.

A lens terminal unit (second terminal portion and accessory-side contact holder) 265 is fixed to an inner circumferential portion of the lens mount 261 by a plurality of screws 266.

In the present embodiment, a mount apparatus (accessory mount) includes the lens mount 261, the lens terminal unit 265, the four screws 263, and the plurality of screws 266. The second mount portion corresponds to the lens mount 261, and bayonet claws and conductive members are provided in the second mount portion.

As described above, an accessory mount according to the present embodiment is attachable to and detachable from a camera mount and includes a second terminal portion that contacts a first terminal portion of the camera mount while the accessory mount is attached to the camera mount. The second terminal portion includes a plurality of terminals that contact a plurality of terminals in the first terminal portion and at least one terminal (2013 to 2016) that does not contact any of the plurality of terminals in the first terminal portion while the accessory mount is attached to the camera mount. In the present embodiment, at least some terminals that are not essential for operation may be omitted, such as ground terminals, a CS terminal, a DCA terminal, or a DLC2 terminal. However, the terminals may be provided for reasons such as measures against short circuits, removal of static electricity, or improvement of communication performance.

The at least one terminal may include two terminals. Heights of the two terminals may differ from each other. The at least one terminal may include a terminal disposed at the outermost position in the circumferential direction. Arranging a plurality of terminals on the same circumference can reduce a radial width of the terminal holder. On the other hand, adopting a configuration in which a plurality of terminals are not arranged on the same circumference (for example, only the at least one terminal is shifted from the same circumference) can prevent an unexpected short circuit when a foreign object enters.

The at least one terminal may include a terminal that contacts at least one of the plurality of terminals in the first terminal portion when the accessory mount is attached to the camera mount. That is, not all of the at least one terminal may contact at least one of the plurality of terminals in the first terminal portion. Alternatively, the at least one terminal may include a terminal that does not contact any of the plurality of terminals in the first terminal portion when the accessory mount is attached to the camera mount.

The present embodiment can properly configure a terminal portion that contacts the camera mount as an accessory mount in the accessory apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-066036, filed on Apr. 14, 2025, which is hereby incorporated by reference herein in its entirety.

What is claimed is:

1. An accessory mount attachable to and detachable from a camera mount that includes a first terminal portion, the accessory mount comprising:
a second terminal portion configured to contact the first terminal portion while the accessory mount is attached to the camera mount,
wherein the second terminal portion includes a plurality of terminals configured to contact a plurality of terminals of the first terminal portion, and at least one terminal configured not to contact any of the plurality of terminals of the first terminal portion while the accessory mount is attached to the camera mount.

2. The accessory mount according to claim 1, wherein the at least one terminal includes two terminals.

3. The accessory mount according to claim 2, wherein the two terminals have different heights.

4. The accessory mount according to claim 1, wherein the plurality of terminals of the second terminal portion include a power supply terminal used for receiving power from the camera mount, and
wherein the at least one terminal includes a terminal disposed adjacent to the power supply terminal.

5. The accessory mount according to claim 4, wherein the power supply terminal is used for receiving power for communication with the camera mount.

6. The accessory mount according to claim 1, wherein the at least one terminal includes a terminal disposed at an outermost position in a circumferential direction.

7. The accessory mount according to claim 1, wherein the plurality of terminals of the second terminal portion include a detection terminal used to detect that the accessory mount is attached to the camera mount, and
wherein the at least one terminal includes a terminal disposed adjacent to the detection terminal.

8. The accessory mount according to claim 1, wherein the plurality of terminals of the second terminal portion include a power supply terminal used for receiving power from the camera mount, and
wherein the at least one terminal includes a terminal having a same height as that of the power supply terminal.

9. The accessory mount according to claim 1, wherein the plurality of terminals of the second terminal portion include a detection terminal used to detect that the accessory mount is attached to the camera mount, and
wherein the at least one terminal includes a terminal having a same height as that of the detection terminal.

10. The accessory mount according to claim 1, wherein the second terminal portion includes a terminal holder that holds the plurality of terminals and the at least one terminal, and
wherein the terminal holder has a first step and a second step protruding toward the camera mount from the first step.

11. The accessory mount according to claim 10, wherein the at least one terminal includes a terminal disposed on the first step and a terminal disposed on the second step.

12. The accessory mount according to claim 10, wherein the plurality of terminals of the second terminal portion include a power supply terminal used for receiving power from the camera mount,
wherein the power supply terminal is disposed on the first step, and
wherein the at least one terminal includes a terminal disposed on the first step.

13. The accessory mount according to claim 1, wherein the at least one terminal includes a terminal configured to contact at least one of the plurality of terminals of the first terminal portion when the accessory mount is attached to the camera mount.

14. The accessory mount according to claim 1, wherein the at least one terminal includes a terminal configured not to contact any of the plurality of terminals of the first terminal portion when the accessory mount is attached to the camera mount.

15. The accessory mount according to claim 1, wherein the at least one terminal includes a ground terminal.

16. The accessory mount according to claim 1, wherein the at least one terminal is configured to contact a predetermined terminal of a mount different from the camera mount when the accessory mount is attached to the different mount.

17. An accessory comprising:
the accessory mount according to claim 1; and
a lens.

18. An accessory comprising:
the accessory mount according to claim 1,
wherein the accessory is attachable to and detachable from a lens apparatus.

19. A camera mount comprising:
the first terminal portion,
wherein the camera mount is attachable to and detachable from the accessory mount according to claim 1.

20. An image pickup apparatus comprising:
the camera mount according to claim 19; and
an image sensor.
